(19) United States
(12) Patent Application Publication
(10) Pub. No.: US 2018/0089668 A1
(43) Pub. Date: Mar. 29, 2018

(54) ON-DEMAND ACTIVE CASH TRANSACTION SYSTEM AND METHOD

(71) Applicant: 46 Degrees Technologies, Inc., Encinitas, CA (US)

(72) Inventors: Garland Wong, Encinitas, CA (US); Francisco Henseleit, Santiago (CL); Sebastian Yunge, Santiago (CL)

(21) Appl. No.: 15/718,302

(22) Filed: Sep. 28, 2017

Related U.S. Application Data
(60) Provisional application No. 62/401,112, filed on Sep. 28, 2016.

(51) Int. Cl. G06Q 20/38; G06Q 20/32; G06Q 20/06; G06Q 30/06; G06Q 20/12

(52) U.S. Cl. CPC G06Q 20/381; G06Q 20/3224; G06Q 20/065; G06Q 30/0641; G06Q 20/123; G06Q 30/0603; G06Q 30/0635

(57) ABSTRACT

The present invention, a system and method for operating a service to arrange and provide active cash transactions between parties through the use of mobile devices, facilitates the purchase of hard and soft goods via cash. The present invention connects a User to an Agent at different geographic locations to meet at a single geographical location to conduct a cash transaction for goods or services in person. The present invention allows for the creation of an on-demand dynamic and active cash collection network where the cash collector and cash buyer can communicate in real time, locate each other, track the location of each other, and meet at a chosen location to conduct a cash transaction. The system enables cash users to use their cash to purchase items that require access to credit, such as digital transactions.

### RELATED APPLICATIONS

This application claims the benefit of priority to U.S. Provisional Patent Application Ser. No. 62/401,112, entitled “On-Demand Active Cash Transaction System and Method,” filed Sep. 28, 2016, and currently co-pending, and which is incorporated herein by reference.

### FIELD OF INVENTION

The present invention relates generally to a system and method for the digital conversion of physical cash. The present invention relates more particularly, but not exclusively, to a system and method for operating a service to arrange and provide digital conversion of currency amongst parties through the use of mobile devices.

### BACKGROUND OF INVENTION

Technology has enabled dramatic changes to commercial transactions in the modern age. The credit card, combined with the telephone, and, more recently, the Internet, has enabled consumers to make instant payments for goods and services without leaving home. The rise of digital goods has created a new type of transaction in which not only payment, but also receipt of the purchased product is virtually instantaneous. For example, a person can purchase a song or a book over the Internet, and download and listen to or read it immediately. Online, or “digital” transaction technology, however, has thus far been unable to seamlessly incorporate one of the oldest, most well-established payment forms: Cash.

An estimated 2.9 billion people are without any access to a banking institution and the credit it offers. The digital network between the world's banking institutions provides for the digital transaction of credit between the different banking institutions, which provides for the seamless transfer of credit. This allows consumers with access to credit to conduct digital transactions with retailers that digitally accept the consumer's credit. However, for consumers without access to credit or the internet, they may be excluded from conducting digital transactions. Additionally, many people still prefer to use cash over credit and thereby prevent themselves from conducting digital transactions. Some online stores accept cash or check payment through mail, but this method of payment eliminates the instant nature of the transaction, and effectively turns the online store into a modern analogue of the mail order catalog. Digital transaction technology has thus left cash-paying consumers behind.

To target these consumers, retailers have provided point of sale terminals or kiosks in brick and mortar storefronts where the buyer travels to the point of sale (“POS”) terminal to perform a cash transaction. The point of sales terminal or kiosk employee takes the consumer's physical cash and conducts a digital transaction for the consumer on the point of sales terminal or kiosk. However, the point of sale terminals or kiosks are scarce and transportation to and from the storefronts is difficult and time consuming.

From the above, a question arises and has thus far gone unanswered: Can an improvement to digital technology be provided to allow instant remote transactions to be made in cash? In light of the above, it would be beneficial to provide a system and method for operating a service to arrange and provide digital conversion of currency amongst parties through the use of mobile devices. It would be further beneficial to provide a method and system that can identify an agent with the capability to provide digital conversion of currency to consumers that require the digital conversion of currency. It would be further beneficial to provide an extension to digital transaction technology which would allow digital transaction systems to accept cash payments. It would be further beneficial to provide an extension to digital transaction technology which would allow consumers to make instant cash payments to an online retailer.

### SUMMARY OF INVENTION

The present invention, a system and method for operating a service to arrange and provide active cash transactions between parties through the use of mobile devices, facilitates the purchase of hard and soft goods via cash. Cash based transactions such as paying of bills, topping up mobile phones, and prepaying for Internet and data services are the predominant cash based transactions being processed. Traditional cash collection networks placed a point of sale terminal or kiosk in a brick and mortar storefront and the buyer needed to travel to the point of sale terminal or kiosk to perform a cash transaction for the goods or service. The present invention provides a mobile platform for cash transactions that can be done anywhere and at any time. The mobile platform provides a better experience for cash buyers because the agent for the retailer, or cash collector, can come meet the buyer to perform the cash transaction, which makes the transaction more convenient for the cash buyer. For the retailers, the mobile platform increases revenue by targeting the population that uses cash, has no access to credit lines, or has difficulty traveling to and from storefronts. For the agents, the mobile platform provides an opportunity to gain income by providing a service for the retailer and the cash buyer. For both buyers and retailers, the mobile platform solves a business problem unique to the Internet by providing the ability to make instant cash payments to an online retailer.

The present invention allows for the creation of an on-demand dynamic and active cash collection network where the cash collector and cash buyer can communicate in real time, locate each other, and track the location of each other. This allows the cash collector to come to the buyer's location to transact the cash transaction. The cash buyer and cash collector decides when and where they want to perform a cash transaction and both parties have an option to accept or decline a cash transaction.

The cash collector is not required to be active 100% of the time and has the option to turn on or off their provided services. Due to the flexibility of the mobile platform, the cash collector is not limited to any particular standard. There may be agent cash collectors who are individuals who download the agent app and make money. They may be delivery cash collectors who are individuals who deliver food such as pizza who want to make additional money by cash collecting. They may be the standard brick and mortar cash collector who wants to expand what they sell by downloading the agent app.

The availably of numerous cash collectors provides cash buyers a broad range of different cash collectors to choose from. The availability of cash collectors and the ability to choose a particular cash collector ensures the cash buyer is satisfied with the experience. To aid the cash buyer in making their choice, several key metrics are provided to the cash buyer: the rating of the cash collector, geographical location of the cash collector, and the pricing of the product or service being offered by the cash collector. Digital goods such as Steam points, Google Play Points, Sony Playstation Network Points, Nintendo E-Shop points, and Microsoft Xbox points may be products sold. These digital goods are codes that can be redeemed in the gaming platform system. Other product and services include bus tickets, event and venue tickets, mobile phone top up (reload) minutes, prepaid mobile internet and data services, and cash collection for other goods and services.

The present invention allows cash buyers to have a presence in the digital marketplace where previously the cash buyers were excluded due to the lack of an available credit source to perform digital transactions. We allow digitally excluded end-users, the cash buyers, to interact with the cash collection network of the present invention. The mobile platform provides access to digital products anytime and anywhere, for end-users paying with cash. The mobile platform allows cash buyers to check product portfolio availability and the purchase of goods in a more efficient and collaborative manner. The previously traditional POS network now has access to a new range of products that they were not able to sell before, passing this benefit on to consumers.

A key process in the system is how does one guarantee that the person or agent collecting the cash does not run off with the money. The key process is the establishment of an escrow account where the agent must top up or prepay an account to begin collecting cash. The Active Cash Transaction (“ACT”) system monitors the escrow accounts of the Agents and will allow an agent to sell only if they have a sufficient balance. The agent then can sell up to the amount in their escrow account. The ACT system allows the agent to markup the digital good and that is how the agent makes money.

The ACT system also allows for an impulse buy whereby the agent can display the digital goods to anybody walking on the street. This means the consumer does not necessarily have to find the agent via the consumer app. The agent can approach the consumer showing him the digital goods on the agent app. If the consumer wishes to purchase the digital good, all they have to do is pay the cash, enter their email, and then the ACT system will email the digital code to the consumer.

The ACT system can also allow for additional services other than collecting cash. For example, cash on delivery and picking up goods for delivery such as Fedex. For example, cash purchases for online goods can be checked before the cash transaction is made thus ensuring the quality of the product before the consumer purchases. The ACT system with its geo-location capability and optimum route selection algorithm is ideal to combine cash collection with other services.

The consumer may be provided with a mobile app with a catalog for making purchases. In a preferred embodiment, however, a cash payment option is provided for integration into third-party websites and mobile apps. The two consumer interfaces aren't mutually exclusive; some embodiments may include both a mobile app and an application programming interface (“API”) for integration into third-party websites and mobile apps.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a high-level flow chart omitting specific details, but which demonstrates the basic operation of the present invention;

FIG. 2 is a high-level flow chart omitting specific details, but which demonstrates the basic operation of an alternative embodiment of the present invention;

FIG. 3 is a diagram showing the basic components of a hardware embodiment of the mobile device;

FIG. 4 is a diagram showing the basic components of the software embodiment of the User App;

FIG. 5 is a diagram showing the basic components of the software embodiment of the Agent App;

FIG. 6 is a diagram showing the basic components of a hardware embodiment of the ACT System;

FIG. 7 is a diagram showing the basic components of the software embodiment of the ACT System;

FIG. 8 is a collection of graphical user interface diagrams representing the User App and the Agent App;

FIG. 9 is a flowchart depicting the operation of a preferred embodiment of the User App at a general level;

FIG. 10 is a flowchart depicting the operation of a preferred embodiment of the Agent App at a general level;

FIG. 11 is a depiction of the catalog interface of the User App;

FIG. 12 is a depiction of the agent selection interface of the User App showing the location of nearby Agents;

FIG. 13 is a depiction of the agent selection interface of the User App showing the details of a selected Agent;

FIG. 14 is a depiction of a map interface of the User App showing the User the location of an Agent that has accepted a purchase request and providing an option to chat with the Agent;

FIG. 15 is a depiction of the catalog interface of the Agent App;

FIG. 16 is a depiction of the catalog interface of the Agent App showing a product price being set;

FIG. 17 is a depiction of the notification interface of the Agent App showing pending purchase requests;

FIG. 18 is a depiction of a map interface of the location interface of the Agent App showing the location of a User with a pending purchase request;

FIG. 19 is a depiction of the catalog interface of the Agent App showing an interface to display the agent type;

FIG. 20 is a depiction of the catalog interface of the Agent App with an interface for changing the agent type;

FIG. 21 is a depiction of an accounting interface of the Agent App with a button to load credit into an agent's account;

FIG. 22 is a depiction of a credit-loading interface of the Agent App;

FIG. 23 is a diagram showing the primary components of the ACT system and their interaction with the User App and the Agent App;

FIG. 24 is a diagram showing the primary components of a preferred embodiment of the ACT system in which a cash payment option is integrated into a third-party marketplace;

FIG. 25 is a flowchart depicting the process of payment to a third-party marketplace through the ACT system from a consumer perspective;

FIG. 26 is a representation of a product selected for purchase on a marketplace;

FIG. 27 is a representation of payment method selection on a marketplace;

FIG. 28 is a depiction of the agent selection interface of the web payment interface showing the location of nearby Agents;

FIG. 29 is a depiction of the consumer interface of the web payment interface instructing the consumer to meet an agent and make a payment;

FIG. 30 illustrates a general overview of the process of purchasing cryptocurrency using the ACT system; and

FIG. 31 illustrates a general overview of the process of selling cryptocurrency using the ACT system.

### DETAILED DESCRIPTION OF THE INVENTION

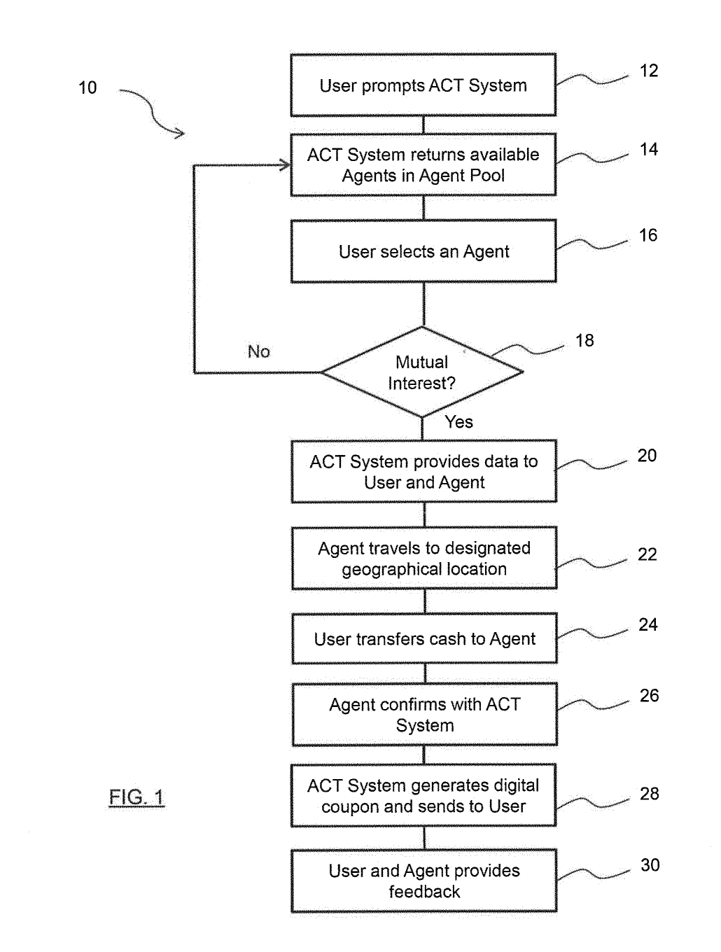

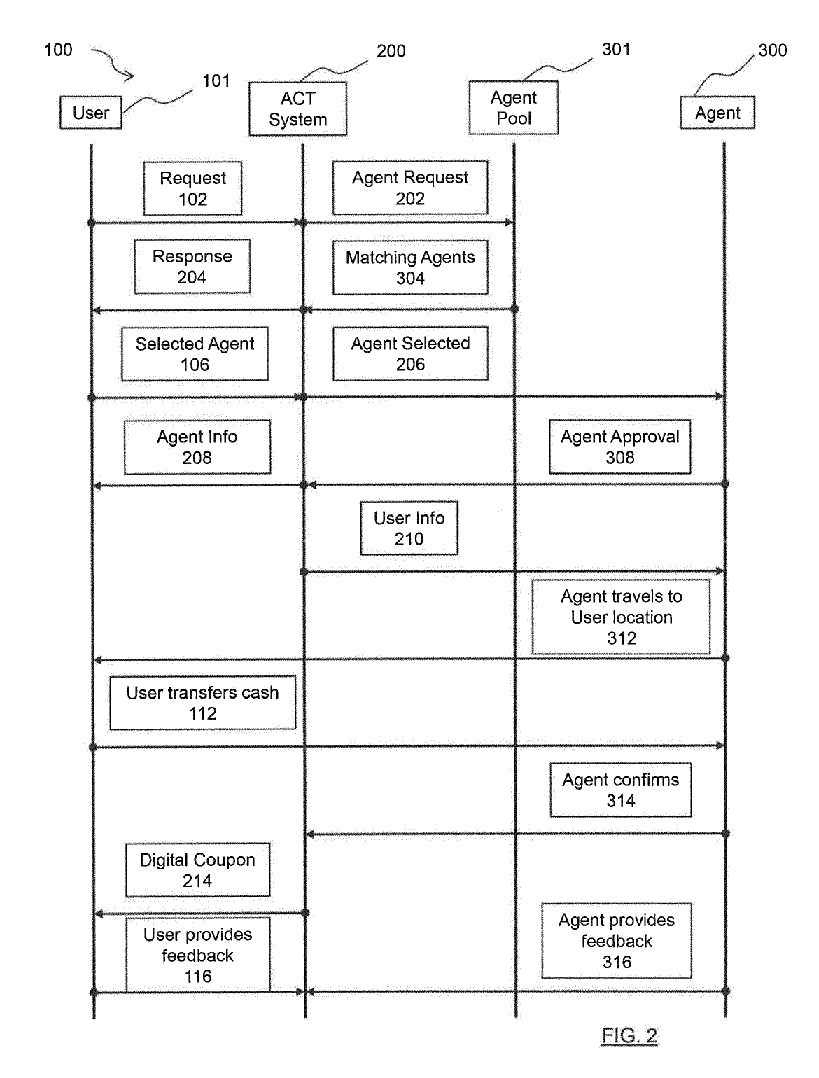

Referring initially to FIG. 1, an embodiment of the system and method for operating an active cash transaction service to arrange and provide active cash transactions amongst parties at different geographical locations through the use of mobile devices is described and generally designated 10. FIG. 1 is a high-level chart omitting specific details, but which in combination with FIG. 2 for reference, demonstrates the basic operation of the present invention. In the embodiment, the system 10 includes a User 101, an Active Cash Transaction (“ACT”) System 200, and an Agent 300 (not shown in the Figure). The User 101 is a cash buyer looking to use cash to purchase goods and services. The Agent 300 is a cash collector and provides goods and services in exchange for cash as payment. The Agent 300 provides goods and services that are digitally based such as Steam points, Google Play Points, Sony PlayStation Network Points, Nintendo E-Shop points, and Microsoft Xbox points. However, the Agent 300 is not limited to selling only digitally based goods and can sell other types of goods and services.

The ACT System 200 connects the User 101 to the Agent 300 at different geographic locations to meet at a single geographical location and conduct a cash transaction for goods or services in person. The present invention allows for the creation of an on-demand dynamic and active cash collection network where the cash collector and cash buyer can communicate in real time, locate each other, track the location of each other, and meet at a chosen location to conduct a cash transaction. The system 10 enables cash users to use their cash to purchase items that require access to credit, such as digital transactions. More particularly, the system 10 allows instant cash payment to an online vendor from a location convenient to the user.

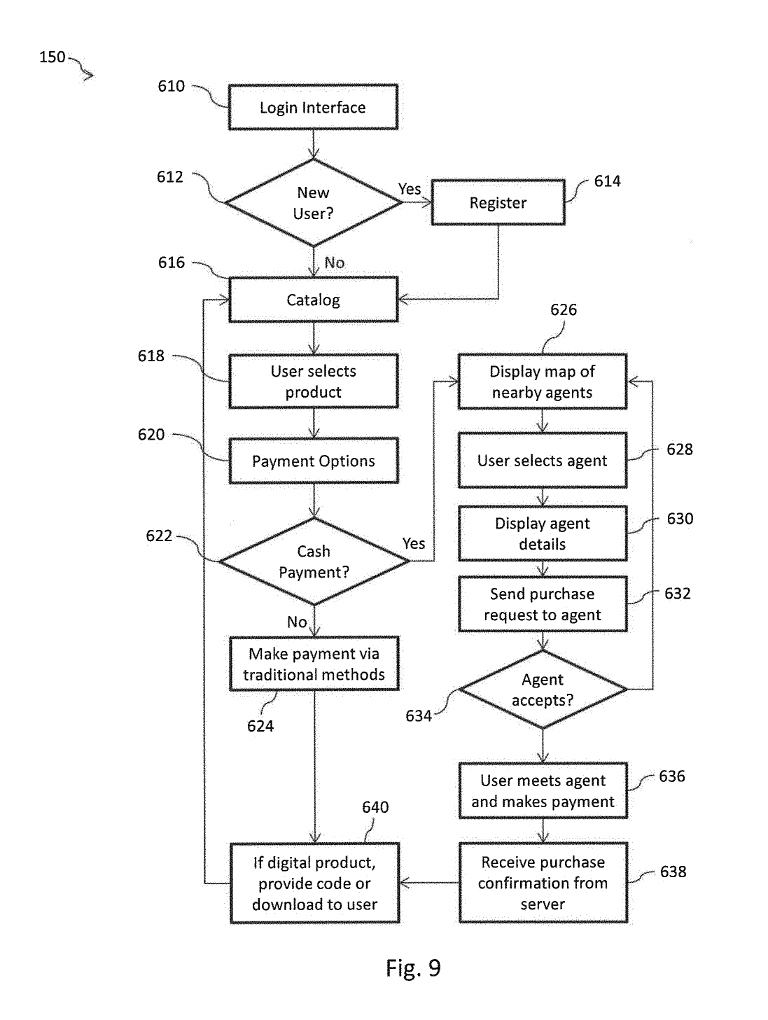

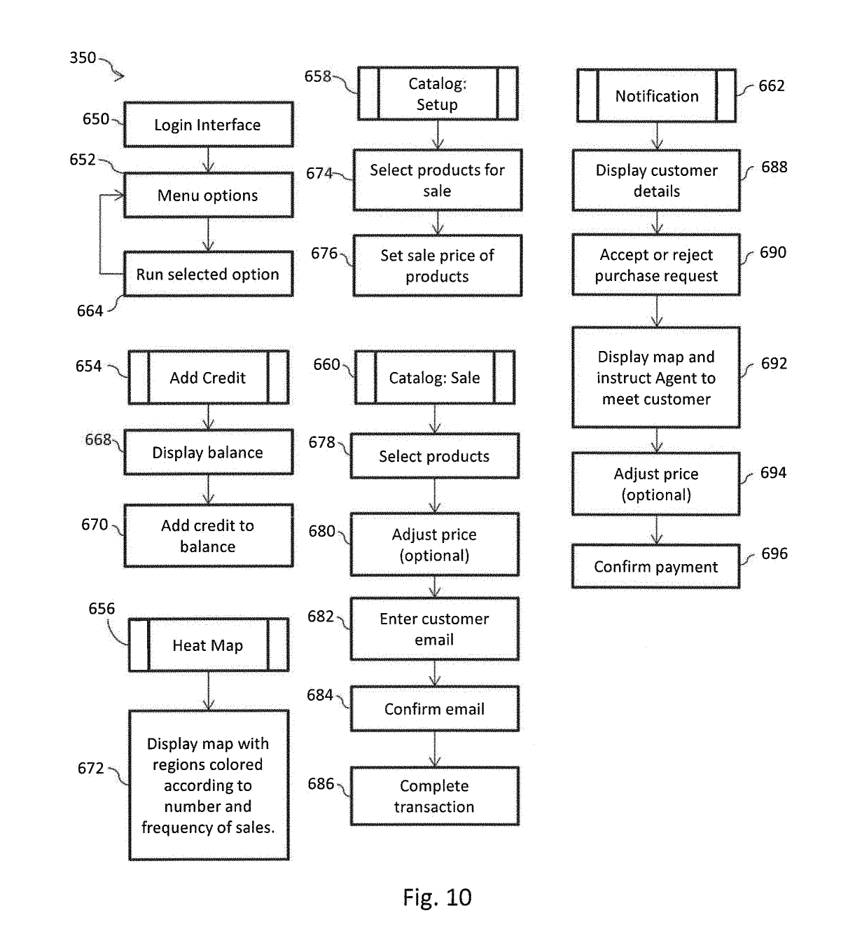

The User 101 utilizes a User App 150 (shown in FIG. 9) and the Agent 300 utilizes an Agent App 350 (shown in FIG. 10) to communicate with the ACT System 101. The User App 350 is an online catalog that displays the products or services that can be bought from the ACT System 200. The Agent App 350 allows an individual to sell products sold on the ACT System 200 and to collect cash for the sale of those products. The Agent 300 can sell all the items offered by the ACT System 101 or only a select few items the Agent 300 believes will be a high-volume seller. The ACT System 200 manages the catalog of products, stores unique identification information of the Users 101 and Agents 300, provides real time chat between Users 101 and Agents 300, and stores real-time data of Users 101 and Agents 300 such as geographic location, products for sale or wanted, etc. The majority of the functions performed by the User 101 and the Agent 300 are performed utilizing the User App 150 and the Agent App 350, respectively. However, the cash transaction occurs in person between the User 101 and the Agent 300.

To engage in an active cash transaction, the User 101 operates the User App 150 to scan the available goods and services currently available in the ACT System 101 and sends a “Prompt the ACT System” 12 to request for a listing of available nearby Agents 300 selling a chosen good or service the User 101 is looking for. Along with the request for goods or service, the User's 101 geographical location, verification identification, User 101 rating, and other data is sent to the ACT System 200. The ACT System 200 determines the available Agents 300 based on whether the Agent 300 is offering the good or service for sale, their geographical location, the User 101 rating, and other data metrics. Once the ACT System 200 determines the list of available Agents 200, the “ACT System returns available Agents in Agent Pool” 14. Once the User 101 receives the Agent Pool listing, the User 101 selects an Agent 300 from the Agent pool and the “User selects Agent” 16 data is then sent to the ACT System 200. The ACT System 200 then prompts the selected Agent 300 and determines if there is “mutual interest” 18 between the Agent 300 and the User 101 by prompting the selected Agent 300. If there is no mutual interest, the ACT System 200 prompts the User to select another Agent 300 and returns the User to step 14. Steps 14-18 will be repeated until mutual interest between the two parties are met.

Once mutual interest between the User 101 and the Agent 300 is confirmed, the ACT System 200 “Provides selected data to the User and the Agent” 20. The data provided to the User 101 includes Agent 300 identification, payment information, and geographical location. Data provided to the Agent 300 includes User 101 identification, payment information, and geographical location. This allows the Agent 300 to travel to the location of the User 101 to conduct the active cash transaction. Once the data is sent to the Agent 300, the “Agent travels to designated geographical location” 22.

Once the Agent 300 arrives to the location of the User 101, the active cash transaction takes place in the physical world. The “User transfers cash to Agent” 24 by handing over cash to the Agent 300. The “Agent confirms with the ACT System” 26 that cash was received. Without the Agent's 300 confirmation the ACT System 200 will not proceed. Once the ACT System 200 receives confirmation from the Agent 300, the “ACT System generates digital coupon and sends to User” 28. The digital coupon can be a redeemable coupon for a digital product or service, a digital payment of a physical good or service, or any other type of goods or service. Once the active cash transaction is complete, the “User and Agent provides feedback” 30 by using their respective User App 150 and Agent App 350.

Referring now to FIG. 2, an alternative embodiment of the system and method for operating an active cash transaction service to arrange and provide active cash transactions amongst parties at different geographical locations through the use of mobile devices is described in detail and is generally designated 100. FIG. 2 is a high-level chart omitting specific details, but which demonstrates the basic operation of the present invention. To engage in an active cash transaction, the User 101 operates the User App 150 to scan the available goods and services currently available in the ACT System 200 and sends a “request” 102 for a listing of available nearby Agents 300 selling a chosen good or service the User 101 is looking for. Along with the request for goods or service, the User's 101 geographical location, verification identification, User 101 rating, and other data is sent to the ACT System 200. The ACT System 200 then sends an “Agent Request” 202 to the Agent Pool 301. The Agent Pool 301 is a listing of all available Agents that are currently active at the time and is updated in real-time as Agents 300 connect and disconnect from the ACT System 200. The Agent Pool 301 returns all available “Matching Agents” 304 to the ACT System 200.

The ACT System 200 then determines the Agents 300 that meet the User's 100 need based on whether the Agent 300 is offering the good or service for sale, their geographical location, the Agent 300 rating, and other data metrics. The ACT System 200 then sends the “Response” 204 to the User 101. Once the User 101 receives the “Response” 204 with the listing of matching agents, the User 101 selects an Agent 300 and “Select Agent” 106 data is sent to the ACT System 200. The ACT System 200 sends a prompt “Selected Agent” 206 to the selected Agent 300. If the Agent 300 has interest in providing the goods and services to the User 100, then the Agent 300 sends an “Agent Approves” 308 to the ACT System 200. If the Agent does not approve, the process is repeated until the User 101 finds an Agent 300 with mutual interest.

Once the User 101 and the Agent 300 have mutual interest, the ACT System 200 sends “Agent Info” 208 to the User 101 and the ACT System 200 sends “User Info” 210 to the Agent 300. The data provided to the User 101 includes Agent 300 identification, payment information, and geographical location. Data provided to the Agent 300 includes User 101 identification, payment information, and geographical location. This allows the Agent 300 to travel to the location of the User 101 to conduct the active cash transaction. Once the data is sent to the Agent 300, the “Agent travels to User location” 312 in the physical world.

Additionally, the “Agent Info” 208 includes data for the amount of cash that may be accepted by the Agent 300. The Agent 300, when initially creating their Agent 300 account also creates a credit account. The credit account dictates the maximum amount of cash that may be received by an Agent 300 from a User 100. When creating the credit account, the Agent 300 deposits credit into the Agent's credit account on the ACT System 200 equal to the maximum amount of cash the Agent 300 wishes to accept from a User 100. The credit deposited by the Agent 300 may be in the form of a credit card, cash deposit, bank transfer, ACT System credit, or other similar credit type payments. The balance on the Agent's 300 credit account dictates how much cash the Agent 300 may collect from the User 100.

As the Agent 300 collects cash from Users 100, which is reported to the ACT System 200 by both the Agent 300 and the User 100, the amount in the Agent's credit account decreases. The decrease in credit in the Agent's credit account will decrease the amount of cash the Agent 300 may collect. With a low balance on the credit account, Users 100 requesting to purchase goods and service with a cash value higher than the balance on the Agent's credit account will not be shown to the Agent and the Agent will not be shown to the Users. Additionally, the Agent 300 will not be able to sell to the User 100 and the User 100 may not be able to purchase from the Agent 300. The Agent 300 may increase or decrease the amount of credit the Agent 300 has in the credit account by depositing credit into their credit account in the ACT System 200. The credit account for the Agent 300 ensures the ACT System 200 is reimbursed for its products sold by the Agent 300.

Once the Agent 300 arrives to the location of the User 101, the active cash transaction takes place in the physical world. The “User transfers cash” 112 to the Agent 300 by handing over cash to the Agent 300. The “Agent confirms” 314 with the ACT System that cash was received. Without the Agent's 300 confirmation the ACT System 200 will not proceed. Once the ACT System 200 receives confirmation from the Agent 300, the ACT System generates a “digital coupon” 214 and sends to User. The digital coupon can be a redeemable coupon for a digital product or service, a digital payment of a physical good or service, or any other type of goods or service. Once the active cash transaction is complete, the “User provides feedback” 116 and the “Agent provides feedback” 316 by using their respective User App 150 and Agent App 350.

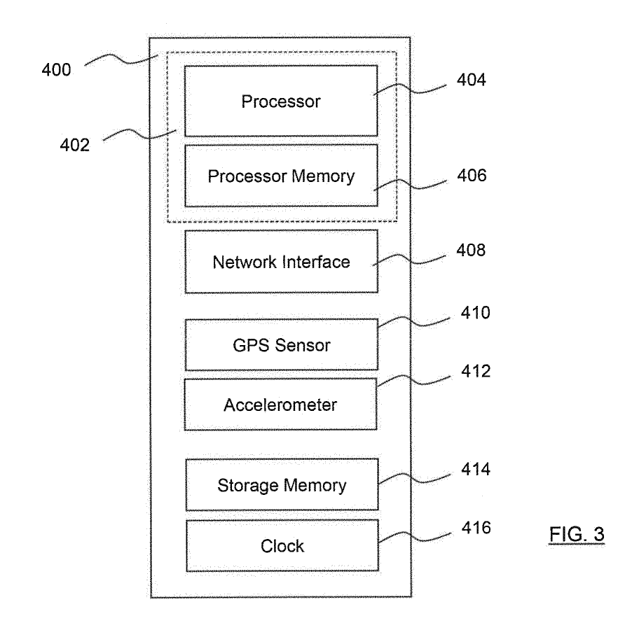

Referring now to FIG. 3, a diagram showing the basic components of a mobile device 400 that operates the User App 150 or the Agent App 350 is shown. The mobile device 400 includes a processing device 402 having a processor 404 and processor memory 406, a network interface 408, a GPS sensor 410, an accelerometer 412, storage memory 414, and clock 416.

The processing device 402 performs the functions of the User App 150 or the Agent App 350 performs various functions required for the operation of the User App 150 or the Agent App 350. The processor 404 may be a microprocessor or other suitable processing component. The processor memory 406 include processor cache, Read Only Memory (ROM), Random Access Memory (RAM), which would contain software instructions executed by the processor 404 to perform the functions of the User App 150 or the Agent App 350. The processor memory 406 may contain firmware specific to the mobile device 400 that is utilized to provide the low-level control program for the components of the mobile device 400.

The clock 416 provides timing and clock functions for the User App 150 or the Agent App 350 and ensures that each component of the mobile hardware 400 is synced to the clock 416. This enables the accurate interaction of the components with each other. The clock 416 also has a system clock to provide accurate current system time for the User App 150 or the Agent App 350. Based on the current system time provided by the clock 416, the User App 150 or the Agent App 350 can sync itself to various external systems which have also synced itself to current system time to allow proper communication, including the ACT System 200. The clock 416 also functions to time stamp the various functions performed by the User App 150 or the Agent App 350 to ensure integrity of the User App 150, the Agent App 350, and the ACT System 200.

The storage 414 stores data that require long-term storage. Generally the User App 150 or the Agent App 350, including the instructions to be executed by the processor 404, will be stored in storage 414, and the instructions will be copied from storage 414 into processor memory 406 in order to be executed on the processor 404. The network interface 408 provides network connectivity through Wireless Fidelity, cellular network, etc. The GPS sensor 410 provides geographical location data and the accelerometer 412 provides acceleration data. Geographic location data may also be obtained by measuring signal strength from nearby mobile network stations (or “cell towers”), or by comparing nearby wireless routers to a database of wireless router locations. Often, location data will be obtained by Assisted GPS (“AGPS”), meaning GPS augmented by information provided by the mobile network.

The mobile device 400 may include various types of mobile devices including, mobile cellular phones, tablets, proprietary mobile devices, embedded devices, or various other mobile type devices. Additionally, the use of the mobile device 400 is not meant to be limiting and any device with a GPS-type sensor may be utilized.

The mobile device 400 must also include a mechanism for providing information to the user (either a User 101 or an Agent 300) and receiving input from the same user. Both requirements are generally satisfied by a touchscreen, but may also use other input and output means known in the art.

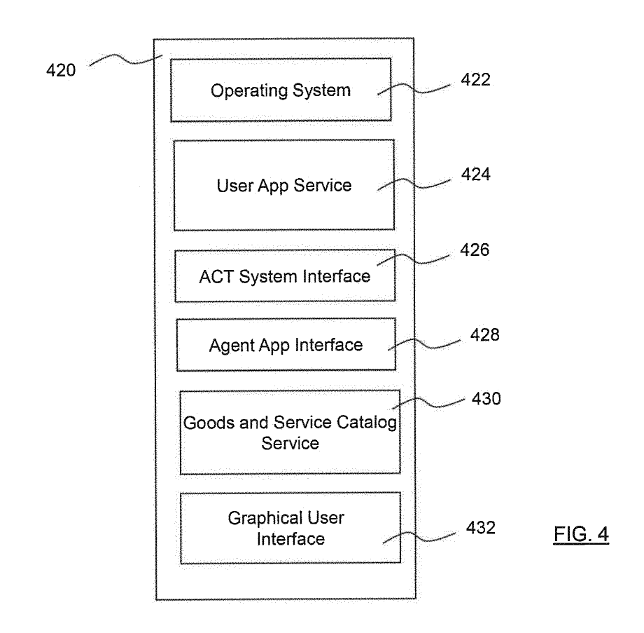

Referring now to FIG. 4 a diagram representing the basic components of the software embodiment 420 of the User App 150 is shown. The hardware embodiment of the User App 150 and the Agent App 350 operates by executing propriety software to perform its various functions. The software embodiment 420 of the User App 150 includes the operating system 422, the User App Service 424, the ACT System Interface 426, the Agent App Interface 428, the Goods and Service Catalog Service 430, and the Graphical User Interface 432.

The operating system 422 is specific to the User App 150 and depends on the various hardware components utilized in the mobile device 400. The operating system 422 also provides the basic services for controlling and interfacing between the hardware components of the mobile device 400 and software components of the User App Service 424, the ACT System Interface 426, the Agent App Interface 428, the Goods and Service Catalog Service 430, and the Graphical User Interface 432. The User App Service 424 includes the services and processes require to operate the User App Service 424 including managing the user data, managing geographical location, managing User 101 preferences. The ACT System Interface 426 manages the services and processes between the User App 150 and the ACT System 200. The Agent App Interfaces manages the services and processes between the User App 150 and the Agent App 350. The Goods and Services Catalog Service 430 manages the goods and services offered by the ACT System 200. The Goods and Services Catalog Service 430 updates the inventory, monitors the selling agents, etc. The graphical user interface 432 allows the User 101 to access the User App 150 functions.

The User App 150 allows a User to register with the ACT System 200 to purchase goods and services from Agents 300. The registration also includes linking with various external applications, programs, and sites such as social media sites. Through the User App 150, the User 101 can edit their profile, preferences, geographical location, credit balances, etc. The User App 150 also provides the capability for Users 101 to check their purchase history to analyze their behavior and how much money they have spent. The purchase history includes location map, agent (name, rank, and a link to see Agent's ranking option) and transaction information). The User App 150 also has the capability to receive rewards points/credits. The rewards points/credits may be used to redeem goods and services from the Agents and can be received through promotions, coupons, or as gifts through the User App 150. The User App 150 also allows the User 101 to rank Agents 300 in terms of reliability, customer interaction, etc. The User App 150, in conjunction with the mobile device 400, provides a secure mechanism to validate transactions.

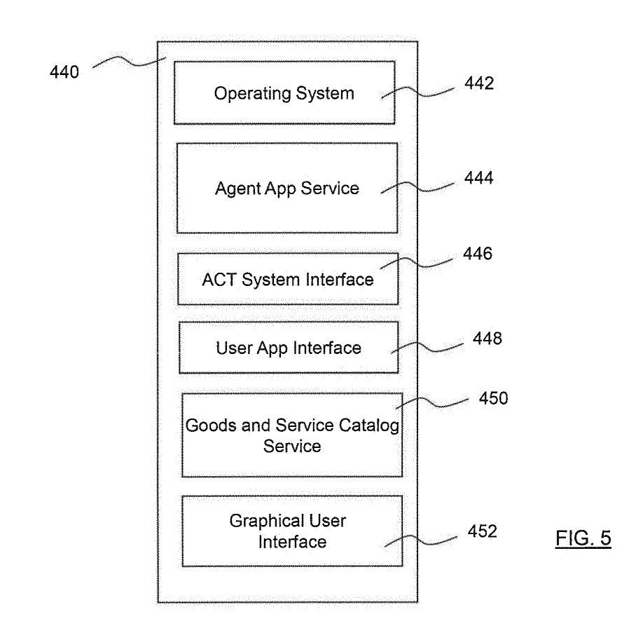

Referring now to FIG. 5, the software embodiment 440 of the Agent App 350 includes the operating system 442, the Agent App Service 444, the ACT System Interface 446, the User App Interface 448, the Goods and Service Catalog Service 450, and the Graphical User Interface 452.

The operating system 442 is specific to the Agent App 350 and depends on the various hardware components utilized in the mobile device 400, including if the mobile device 400 is using any particular type of firmware. The operating system 442 may also provide the basic services for controlling and interfacing between the hardware components of the mobile device 400 and software components of the Agent App Service 444, the ACT System Interface 446, the User App Interface 448, the Goods and Service Catalog Service 450, and the Graphical User Interface 452. The Agent App Service 444 includes the services and processes require to operate the Agent App Service 444 including managing the user data, managing geographical location, managing Agent 300 preferences. The ACT System Interface 446 manages the services and processes between the Agent App 350 and the ACT System 200. The User App Interface 448 manages the services and processes between the Agent App 350 and the User App 150. The Goods and Services Catalog Service 450 manages the goods and services offered by the ACT System 200 that the Agent 300 is selling. The Goods and Services Catalog Service 450 updates the inventory, monitors other selling agents, etc. The graphical user interface 452 allows the Agent 300 to access the Agent App 350 functions.

The Agent App 350 allows an agent to register with the ACT System 200 to provide agent services. The registration also includes linking with various external applications, programs, and sites such as social media sites. Through the Agent App 350, the Agent 300 can edit their profile, preferences, geographical location, goods and service catalog balances, credit balances, etc. The Agent App 350 also provides the capability for Agents to check their balance and commissions history to analyze their behavior and how much money they have made. The Agent App 350 also has the capability to set on/off their location status and set their place and hours that they will be available as a mobile or as a static agent. The agent has the capability to set their specific location manually, in case the phone localization is not accurate, or to have Users 101 travel to the Agent 300 instead. The Agent App 350 is also capable of receiving real-time data such as near consumers making a purchase, when a consumer wants to purchase, promotions, newsletters, etc. The Agent App 350 also has the capability of showing customer evaluations of the Agent 300, comparison between the Agent 300 and other agents, and profile views. The Agent App 350 also allows the Agent 300 to rank Users 101 in terms of reliability, customer interaction, etc. The Agent App 350, in conjunction with the mobile device 400, provides a secure mechanism to validate transactions to registered or unregistered customers.

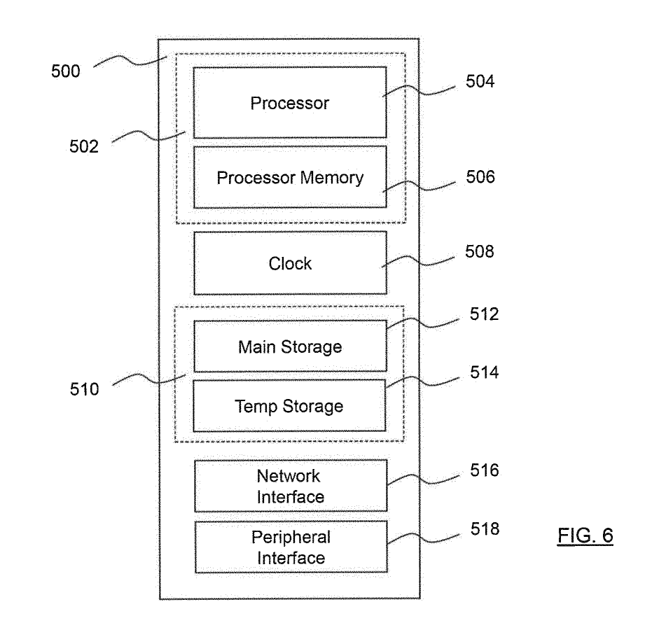

Referring now to FIG. 6, a diagram showing the basic components of a hardware embodiment of the ACT Service 200 is shown. The hardware embodiment of the ACT Service 500 includes a processing device 502 having a processor 504 and processor memory 506, a clock 508, a storage 510, a network interface 516, and a peripheral interface 518.

The processing device 502 performs the functions of the system such as managing Users and Agents, managing security rights, and managing access to information. The processing device 502 also performs various other functions required for the operation of the ACT System 200. The processor 504 may be a microprocessor or other suitable processing component. The processor memory 506 includes processor cache, Read Only Memory (ROM), Random Access Memory (RAM), which would contain software instructions executed by the processor 504 to perform the functions of the ACT System 200.

The clock 508 provides timing and clock functions for the ACT System 200 and ensures that each component of the physical embodiment 500 of the ACT System 200 is synced to the clock 508. This enables the accurate interaction of the components with each other. The clock 508 also has a system clock to provide accurate current system time for the ACT System 200. Based on the current system time provided by the clock 508, the ACT System 200 can sync itself to various external systems which have also synced itself to current system time to allow proper communication.

The storage 510 includes main storage 512 and temporary storage 514. The main storage 512 stores User/Agent data, goods and service data, and various other data that requires long term storage. The temp storage 514 stores temporary data before transferring to the main storage 512. The temp storage 514 stores real-time data of Users and Agents including geographical location, product prices, and etc. The network interface 516 provides network connectivity through Wireless Fidelity, cellular networks, etc. The peripheral interface 518 allows connectivity to external peripheral devices via standard interfaces such as RS-232, PCMCIA, or FDDI.

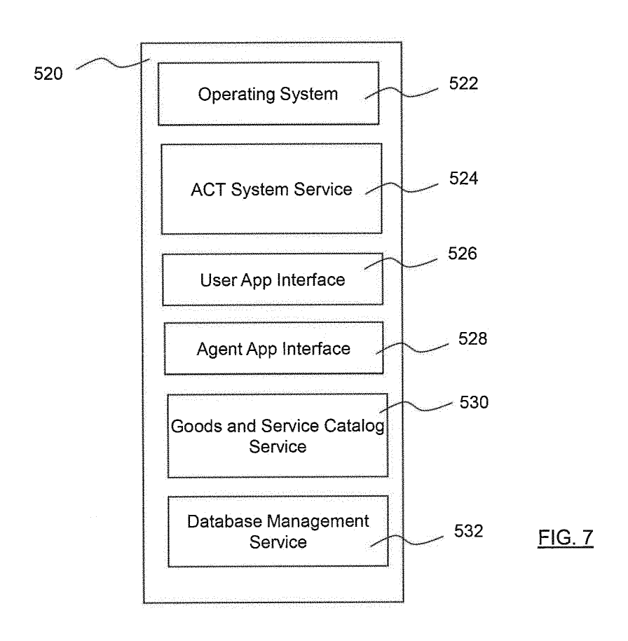

As shown in FIG. 7, the hardware embodiment of the ACT System 200 operates by executing propriety software to perform its various functions. The software embodiment 520 of the ACT System 200 includes the operating system 522, the ACT System Service 524, the User App Interface 526, the Agent App Interface 528, the Goods and Service Catalog Service 530, and the Database Management Service 532.

The operating system 522 is specific to the ACT System 200 and depends on the various hardware components utilized in the ACT System 200. The operating system 522 also provides the basic services for controlling and interfacing between the hardware and software components of the ACT System 200, the User App 150, the Agent App 350, and other various external services. The database services 532 manages the data stored and provides input/output services. The ACT System Service 524 includes the services and processes require to operate the ACT System 200 including managing the Agent and User data, managing geographical location, etc. The User App Interface 526 manages the services and processes between the ACT System 200 and the User App 150. The Agent App Interface 528 manages the services and processes between the Agent App 350 and the ACT System 200. The Goods and Services Catalog Service 530 manages the goods and services offered by the ACT System 200. The Goods and Services Catalog Service 530 updates the inventory, monitors other selling agents, etc. The Database Management Service 532 manages the data stored in the ACT System 200.

The ACT System 200 manages the interaction between the User 100 and the Agents 300. The ACT System 200 also provides information to the User 100 and Agents 300 that aids the interaction between the two parties. The ACT System 200 also analyzes Agent and User behavior for analyses and use. The ACT System 200 performs the processing for the User App 150 and the Agent App 350, wherein the User App 150 and the Agent App 350 shows the processed data.

The ACT System 200 can generate an Agent's Map for the User to show the User which Agents are close to the User. The Agent Map is not limited to a single geographical location but can be changed according to the User's preference. The Agent Map is updated in real-time to show the movement of Agents, the Agent with the lowest prices, etc. The ACT System 200 also generates a Heat Map, which shows where the most active cash transactions are made so the Agent can target those particular areas. The heat map can also show the most popular times, the best-selling price, etc.

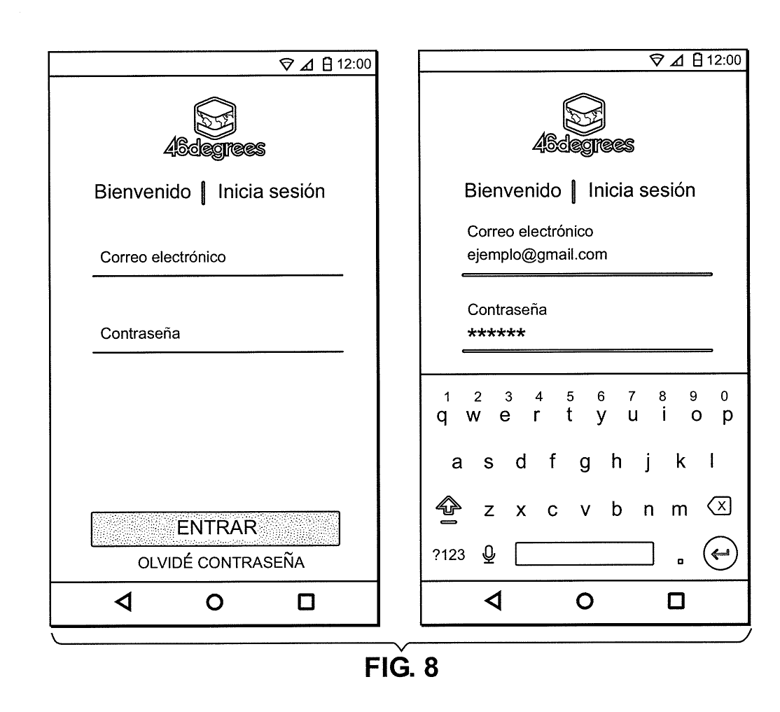

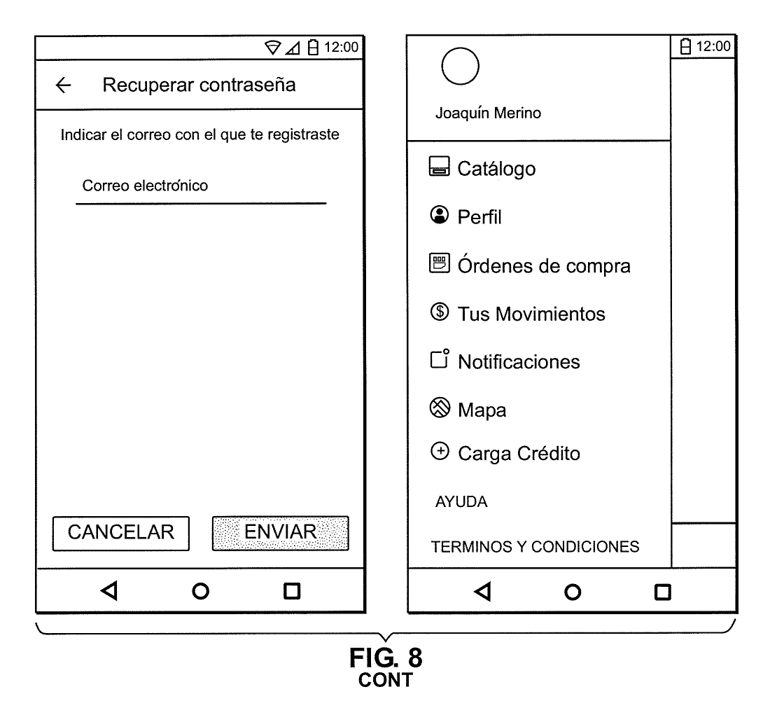

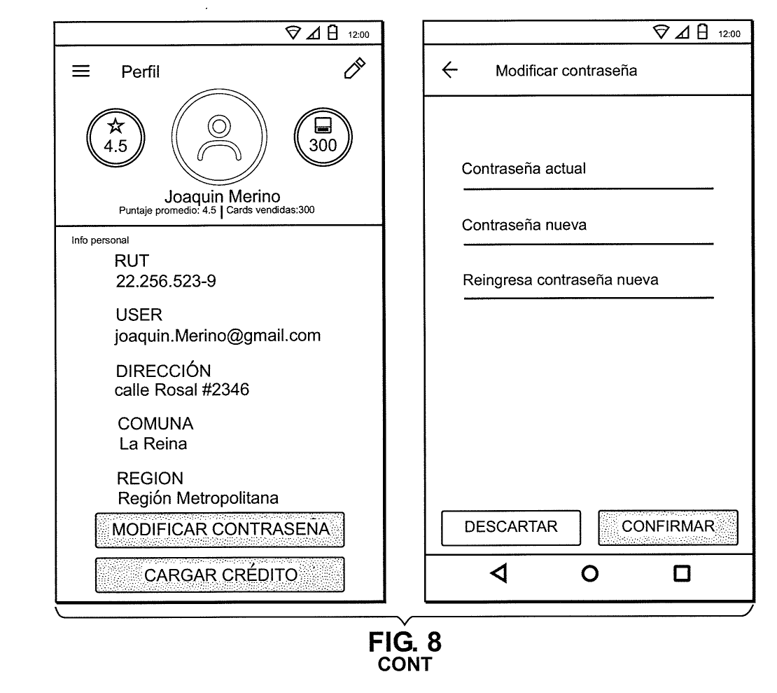

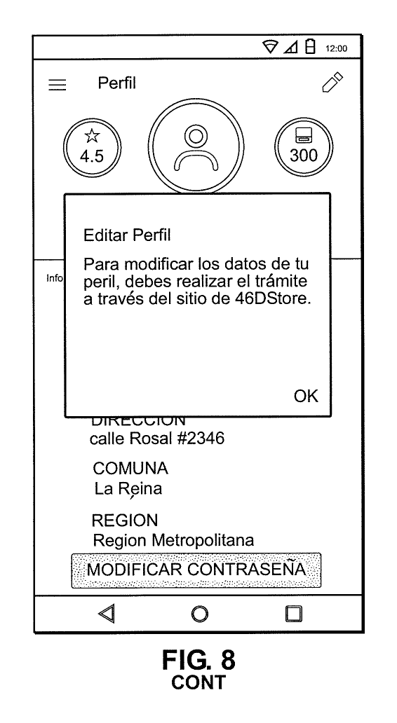

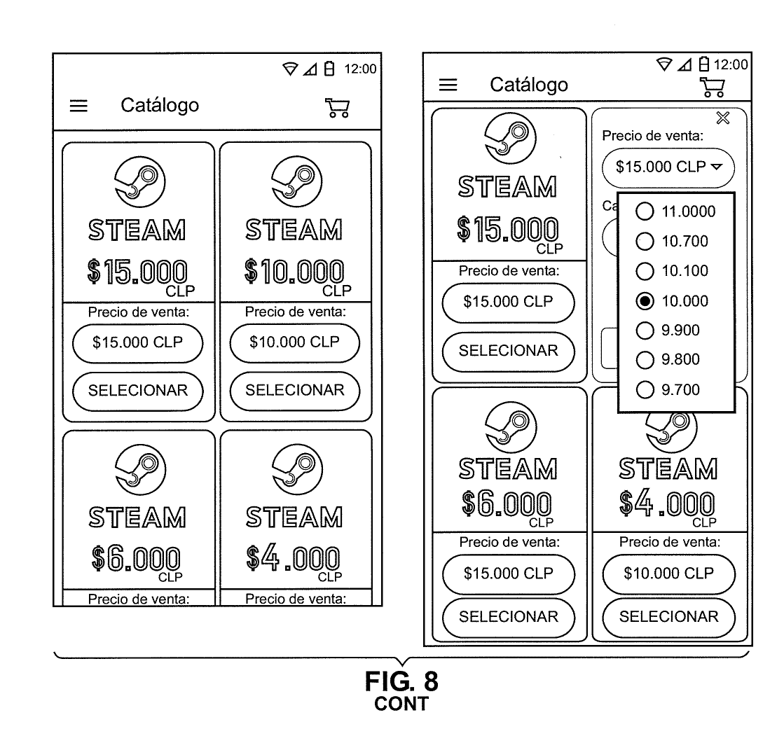

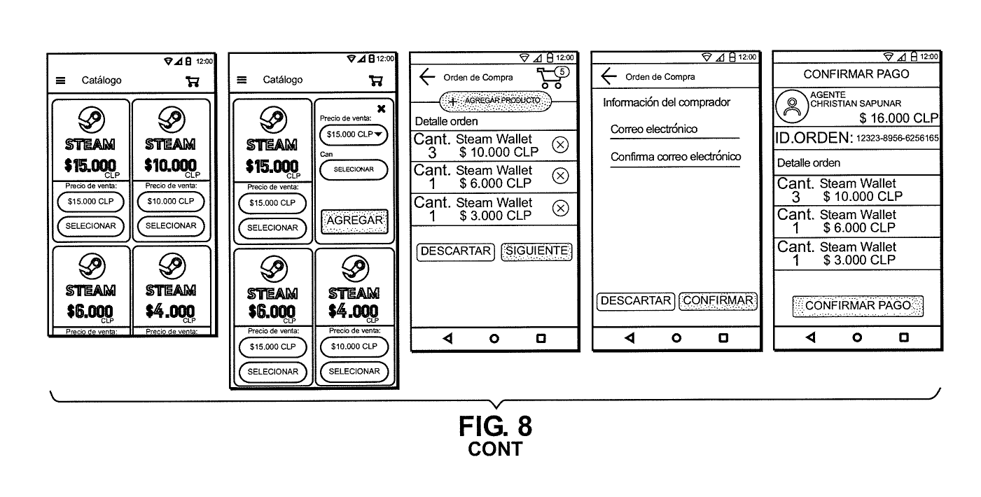

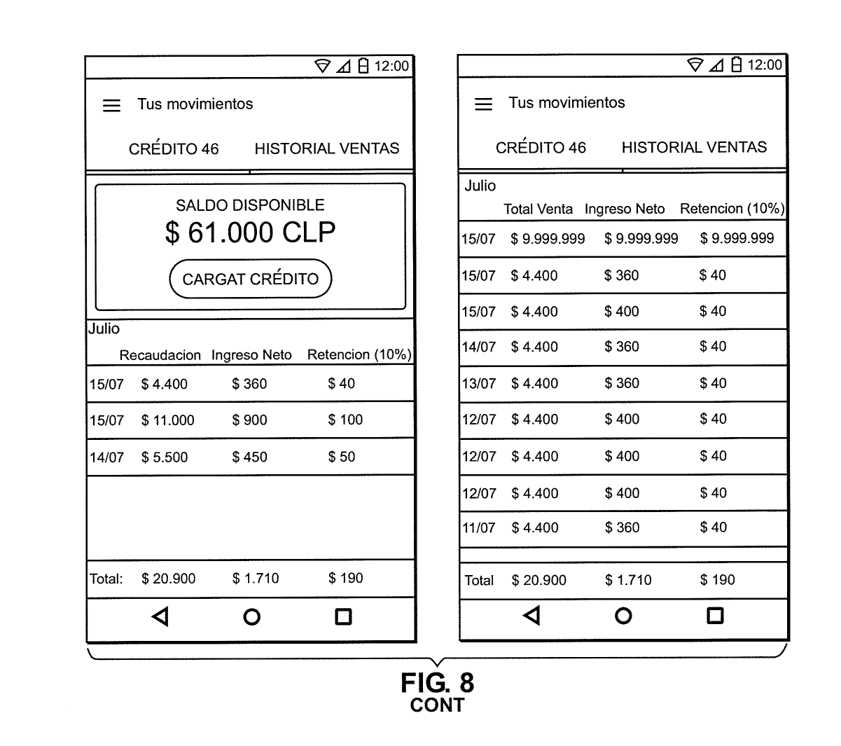

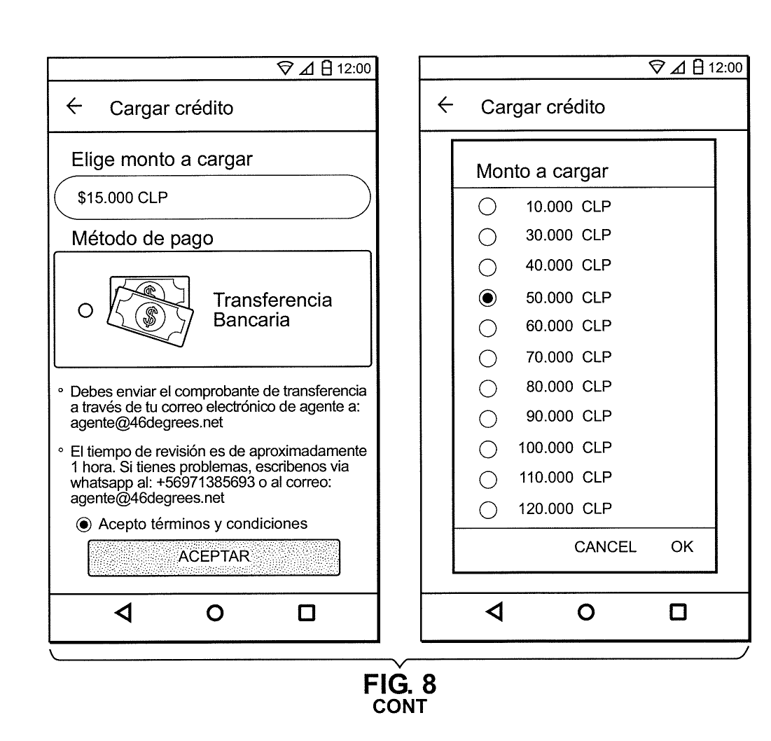

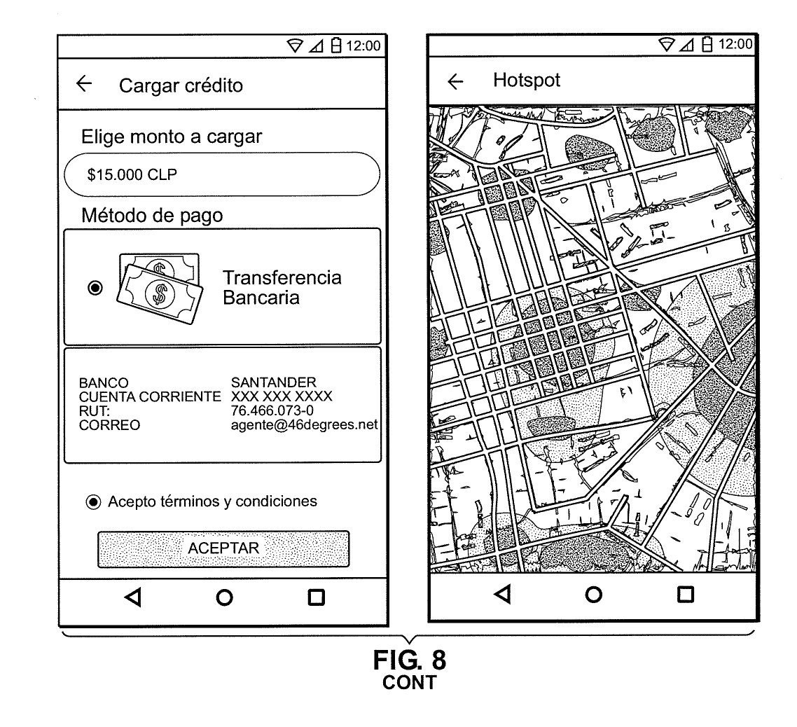

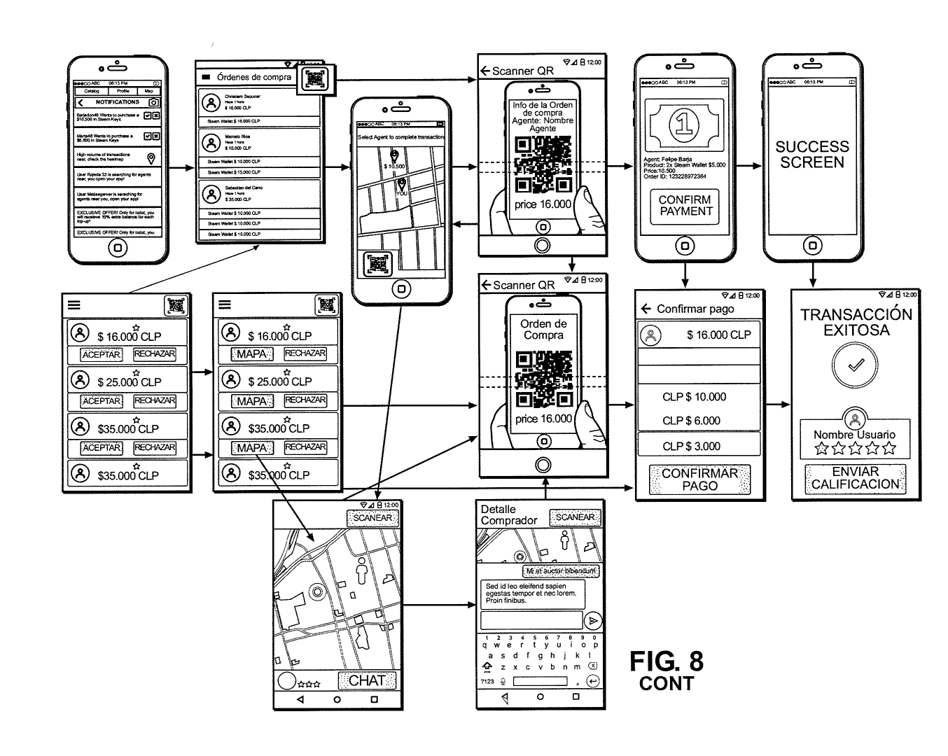

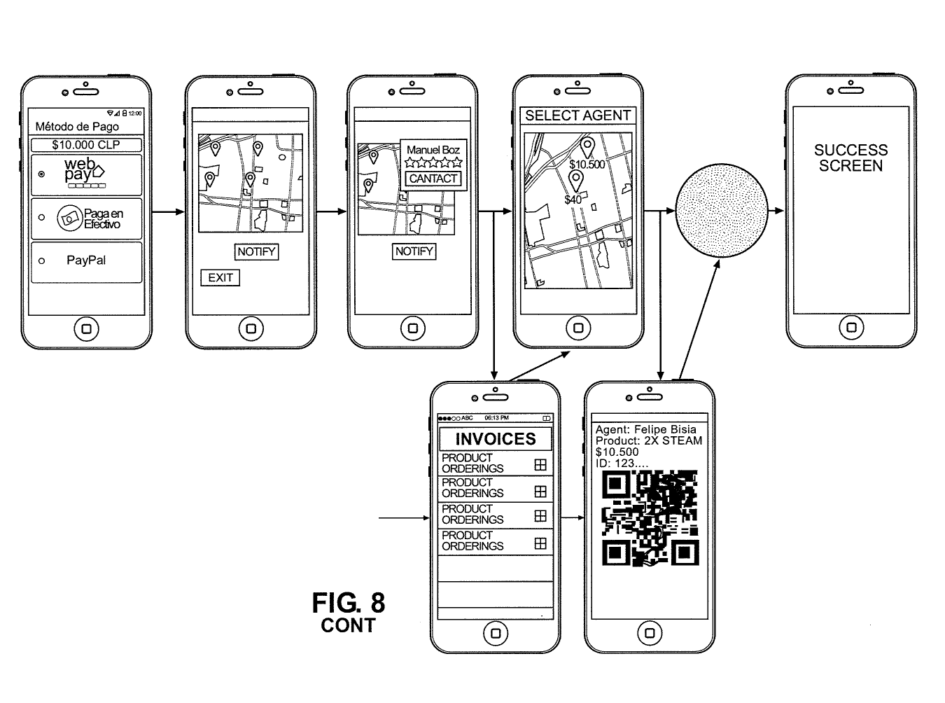

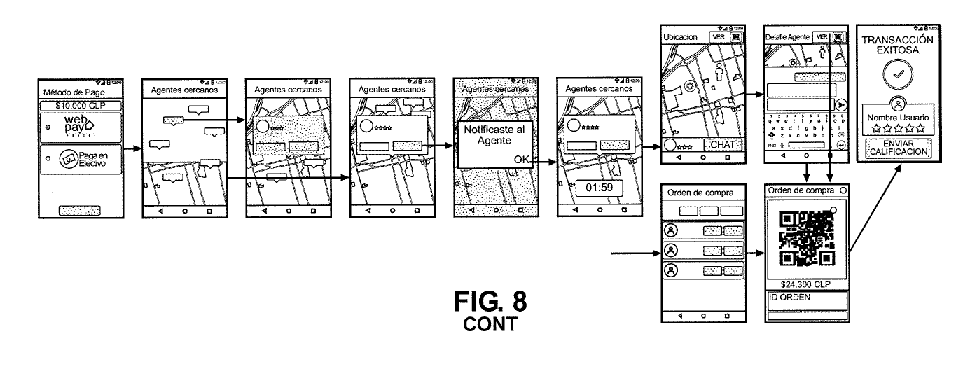

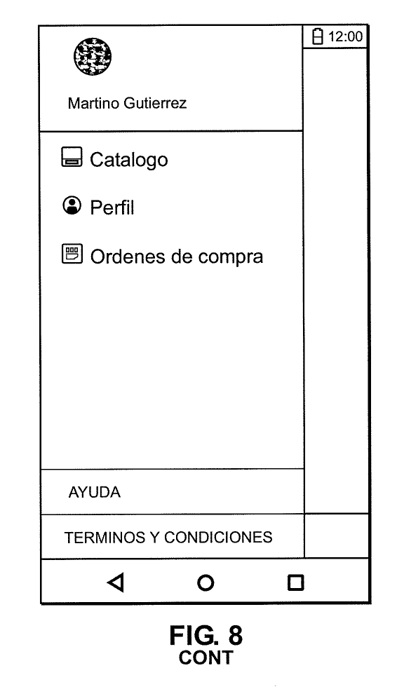

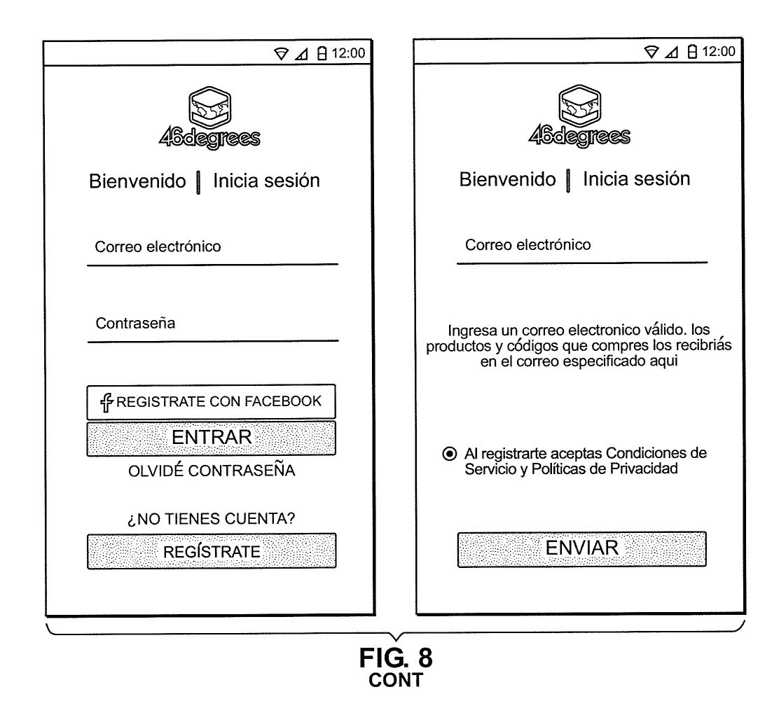

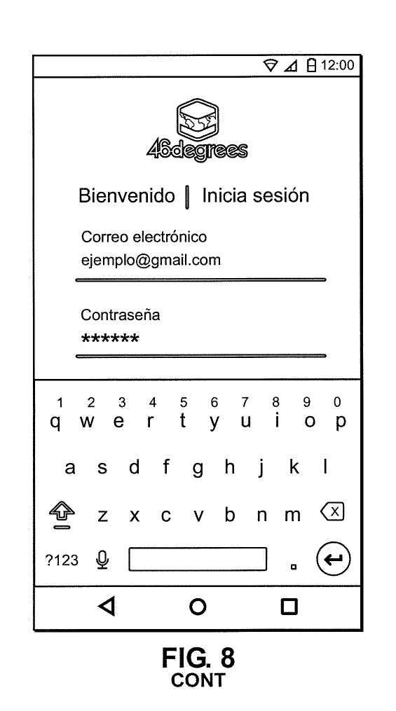

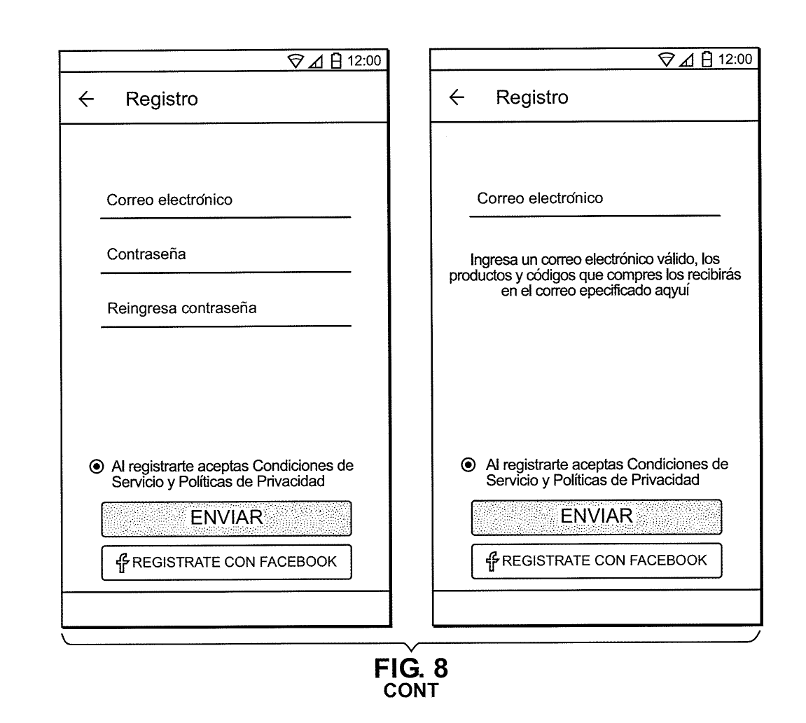

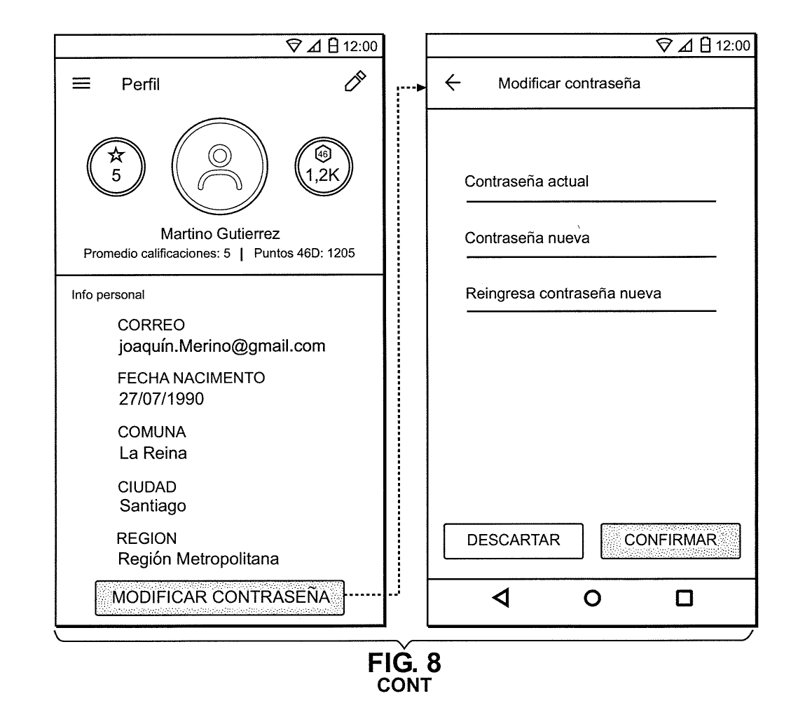

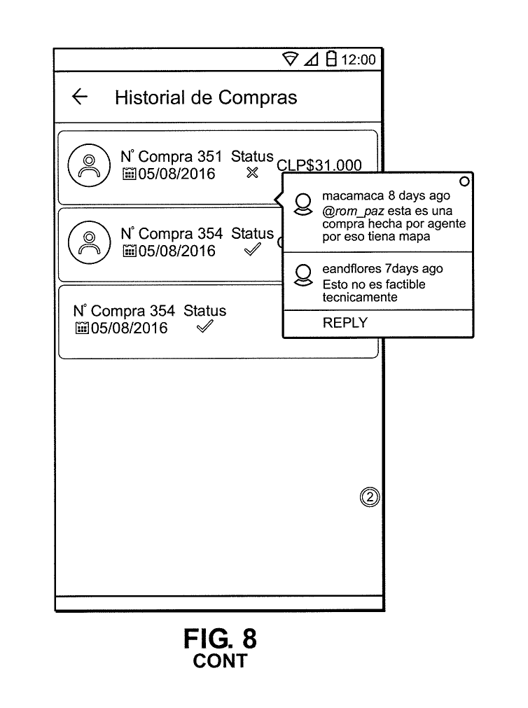

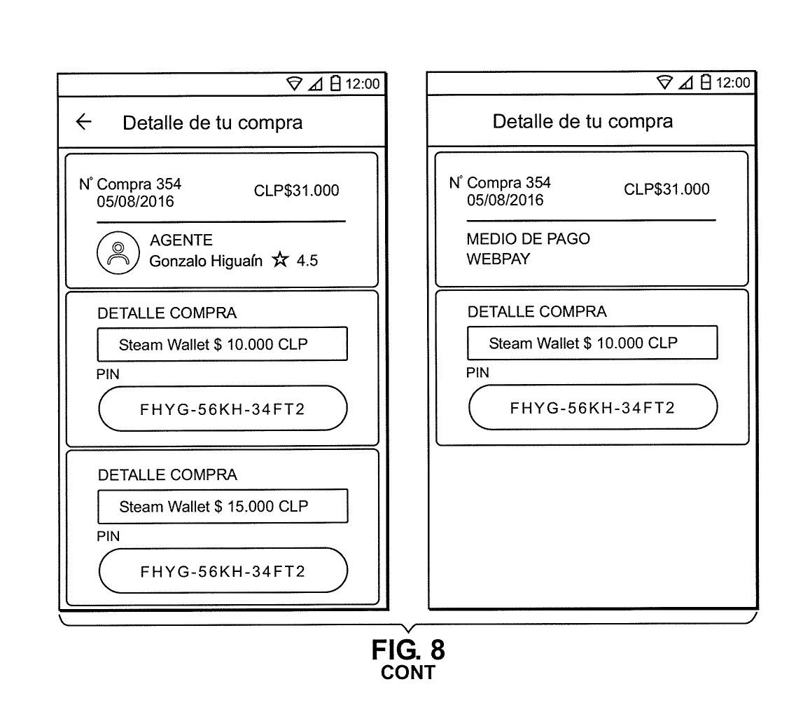

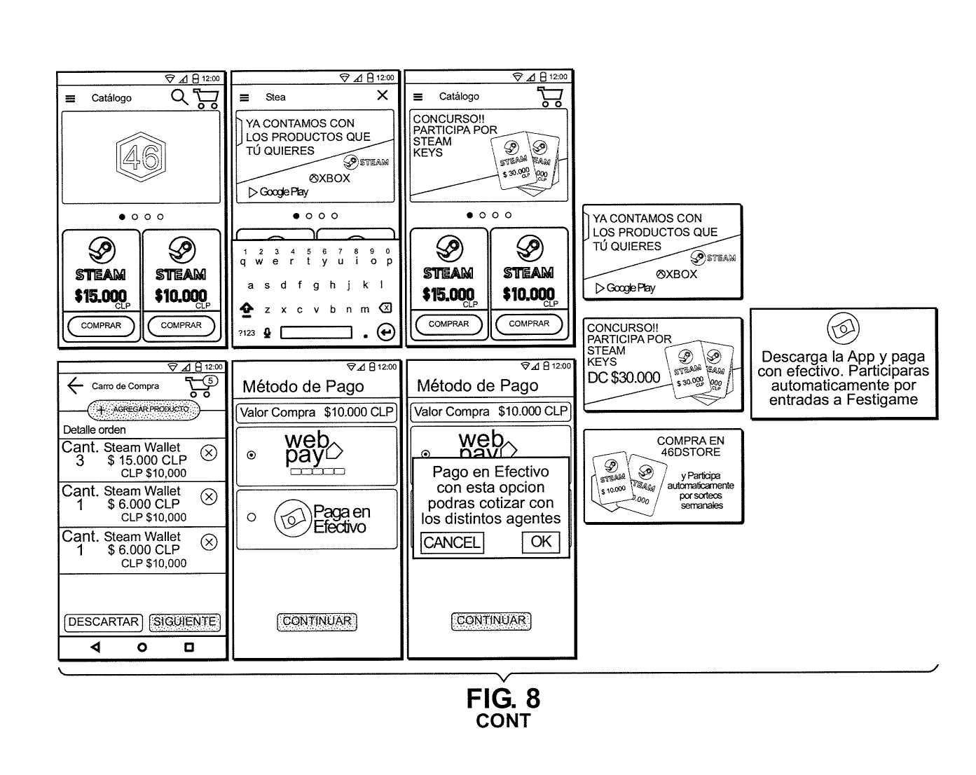

Referring now to FIG. 8, a collection of diagrams representing the graphical user interface of the User App and the Agent App is shown. The text on the graphical user interface is in Spanish, but is not limited to a single language. It is contemplated that any language may be used for the graphical user interface to communicate to the User or Agent.

Referring now to FIG. 9, a flowchart showing a general overview of an implementation of a preferred embodiment of the User App 150 is shown. As discussed in conjunction with FIG. 3, in a preferred embodiment the User App 150 runs on a mobile device 400. However, the User App 150 can be implemented on other types of computing devices, as long as a network connection is available which allows the User App 150 to communicate with the ACT system 200. In situations in which a GPS is not present in the computing device, such as when the User App 150 is running on a desktop or laptop computer without a GPS unit, the User 101 would manually input the user's location into the User App 150. In preferred embodiments implemented on a mobile device 400 with a GPS sensor 410 or other location service, the User App 150 obtains the location of the User 101 automatically via the GPS sensor 410 or location service, without requiring the User 101 to manually input a location.

When the User App 150 is initially run, a login interface 610 is displayed to the User 101. The login interface 610 has an option to log in as an existing user, or to register a new account. If the User 101 is a new user 612, the User 101 selects the registration option, and is presented with a registration interface 614 which allows the User 101 to create a new account and profile for interacting with the ACT System 200.

When the User 101 registers or logs in, a catalog 616 is presented. The User App 150 also provides, generally in a menu accessible from the catalog 616 interface, options for modifying the profile of the User 101, viewing purchase history, viewing pending orders, and accessing an online help system.

The User App 150 allows the User 101 to browse the catalog and select one or more products and services for purchase. Once product selection 618 is complete, the User 101 begins the checkout process and is presented with payment options 620. In addition to cash payment, the payment options may include traditional methods for online payments, including credit card or services such as PayPal®. If the User 101 does not elect cash payment 622, a traditional online payment 624 interface is presented.

When the User 101 elects to make a cash payment 622, the User App 150 then displays a map of nearby agents 626. More particularly, the location of the User 101 is sent to the ACT System 200, which looks up nearby active agents 300 with sufficient balance to complete the transaction. The list of agents 300 is communicated to the User App 150, which then displays their locations on a map 626. The User 101 selects an Agent 300. Once the user selection 628 is made, the details 630 of the Agent 300 are shown, including the price at which the selected products are offered by the Agent 300 and the rating of the Agent 300. The User 101 can then decide to send a purchase request 632 to the Agent 300. A purchase request 632 has a limited lifetime, after which the User 101 is returned to the map 626 to select another Agent 300. In a preferred embodiment of the present invention, the lifetime of a purchase request 632 is two (2) minutes. This prevents long waiting times if a particular Agent 300 is logged in as active, but away from his or her mobile device 400 or otherwise inattentive to requests at the time. The Agent 300 may accept or reject a purchase request 632. An acceptance notification 634 is sent to the User App 150 communicating whether the Agent 300 accepted or rejected the purchase request 632. If the Agent 300 rejected the purchase request 632, the User App 150 displays the map 626 to allow the User 101 to select another Agent 300.

Between the time a purchase request 632 is made and the time payment is confirmed by the Agent 300, the User 101 and the Agent 300 may be permitted to chat with each other, e.g. through a chat dialog on the map interface, in order to decide or change where payment will be made.

Once a purchase request 632 is made and accepted, the User App 150 directs the User 101 to meet with the Agent 300 to make payment. An order code or, in a preferred embodiment, a QR code representing the order is displayed on the User App 150, which the Agent 300 can scan or enter in order to make the payment confirmation. If available on the mobile devices 400, NFC may also be used to confirm payment. Alternatively, the necessary information may be sent automatically to the Agent App 350 with the original purchase request 632, and the Agent 300 only needs to hit a button on the Agent App 350 to complete the transaction. The use of a QR code, NFC, or a manually entered code (the Agent 300 or the User 101 may be given the option to select a particular method) in a preferred embodiment prevents the Agent 300 from accidentally confirming payment before meeting with the User 101. Once the meeting and payment 636 take place, an order confirmation 638 is sent from the ACT System 200 to the User App 150.

Once the user has either made a traditional online payment 624, or an order confirmation 638 for a cash payment has been received from the ACT System 200, the User 101 may be permitted to download any digital goods or view any product keys that were purchased. The User App 150 may provide a product interface 640 to enable instant download or viewing of purchased digital products. At this stage, the User 101 may return to the catalog 616 in order to continue browsing and make additional purchases. After the transaction is completed, the User 101 may be invited to rate the Agent 300. If the User 101 does so, the rating selected by the User 101 is saved and used to calculate the rating of the Agent 300 shown in the Agent details 630.

Alternative embodiments of the User App 150 include a program running on a desktop or laptop computer, or a web-based service running in a web browser. These embodiments generally follow the steps described above, with the adaptations necessary to the specific platform.

Referring now to FIG. 10, a flowchart showing a general overview of a preferred embodiment of the Agent App 350 is shown. When the Agent App 350 is initially opened, a login interface 650 is presented. Once the Agent 300 logs in, a menu 652 with several options is presented. Directly or indirectly from the menu 652, the Agent 300 can select the following procedures: Add Credit 654, Heat Map 656, Catalog, which comprises both Setup 658 and Sale 660 procedures, and Notifications 662. Other procedures may be available in order to update a profile, access on-line help, and complete other tasks that are necessary or useful to the Agent 300. The Agent 300 makes a selection from the menu 652, upon which the Agent App 350 runs the procedure corresponding to the selected option 664.

The Add Credit 654 procedure displays the credit balance 668 of the Agent 300. The Agent App 350 communicates with the ACT System 200 in order to obtain the most up-to-date balance in the account of the Agent 300. In the Add Credit 654 procedure, the Agent 300 is provided with an option 670 to add credit to the balance. One or more options are provided for adding credit to the account balance of the Agent 300. These options may include bank transfer, credit card payment, or a payment service such as PayPal®, WebPay, or Khipu.

The Heat Map 656 procedure displays a map of the local area with regions colored according to the number and frequency of sales. The Agent App 350 allows the Agent 300 to set his or her status as online (available to receive payments) and offline (in which the agent will not appear on the map of any user). In a preferred embodiment of the Agent App 350, the online status is changed on the Heat Map 656 interface.

The catalog has features for setup 658 of the Agent's offerings. The agent can select 674 some or all of the available products for sale, and can set 676 the price at which he or she sells each product. More particularly, the Agent 300 can select a product and be provided with a set of price options, including a recommended price and several prices above and below the recommended price. The Agent 300 may choose a higher price for a product having high demand in order to receive a higher commission, or may choose a lower price to attract Users 101. The present invention may be used with a variety of commission programs for Agents 300, including a percentage of each sale, or a percentage or fixed amount per product to which is added or subtracted the amount at which the Agent 300 sells above or below the recommended price. It is also contemplated that in some uses no commission is provided to Agents 300 at the recommended price, and the Agent 300 must select a higher amount in order to make money from the transaction.

The catalog also offers an impulse sale 660 option, which can be used to sell to a customer who does not have the User App 150. In order to make a sale to a customer without the User App 150, one or more products 678 are selected from the catalog on the Agent App 350. Optionally, there may be a feature to allow the Agent 300 to make a price adjustment 680, e.g. to offer a discount in order to make the sale. Once the products are selected and any price adjustments applied, the Agent App 350 displays an entry form 682 for the customer's email address. A confirmation 684 of the email address is requested, payment is made, and the transaction is completed 686. A link is then sent to the customer's email address in order for the customer to access any digital goods sold in the transaction. Alternatively, the Agent App 350 may request a physical address for shipment of physical goods ordered.

The Agent 300 is notified whenever a purchase request is made to the Agent 300 by a User 101. A Notification 662 procedure is provided for the Agent 300 to view pending notifications. When the Agent 300 selects a purchase request notification for viewing, details 688 of the User 101 who made the notification are displayed, including the amount of the purchase, the name of the User 101, and the rating of the User 101. Upon display of the details 688, the Agent App 350 asks the Agent 300 to accept or reject 690 the purchase request. If the purchase request is accepted, a map 692 is displayed and the Agent 300 is asked to meet with the User 101 in order to complete the transaction. Optionally, there may be a feature to allow the Agent 300 to make a price adjustment 694, e.g. to offer a discount in order to make the sale. The Agent 300 is asked to confirm 696 the payment. In preferred embodiments, this is done by scanning a QR code on the device of the User 101, using NFC, or entering a code given to the User 101 by the User App 150. Once payment is confirmed 696, the ACT System 200 notifies the User App 150. The Agent App 350 then invites, or, in some embodiments, requires the Agent 300 to rate the User 101. The rating selected by the Agent 300 is used in calculations of the rating of the User 101 shown in notifications of purchase requests.

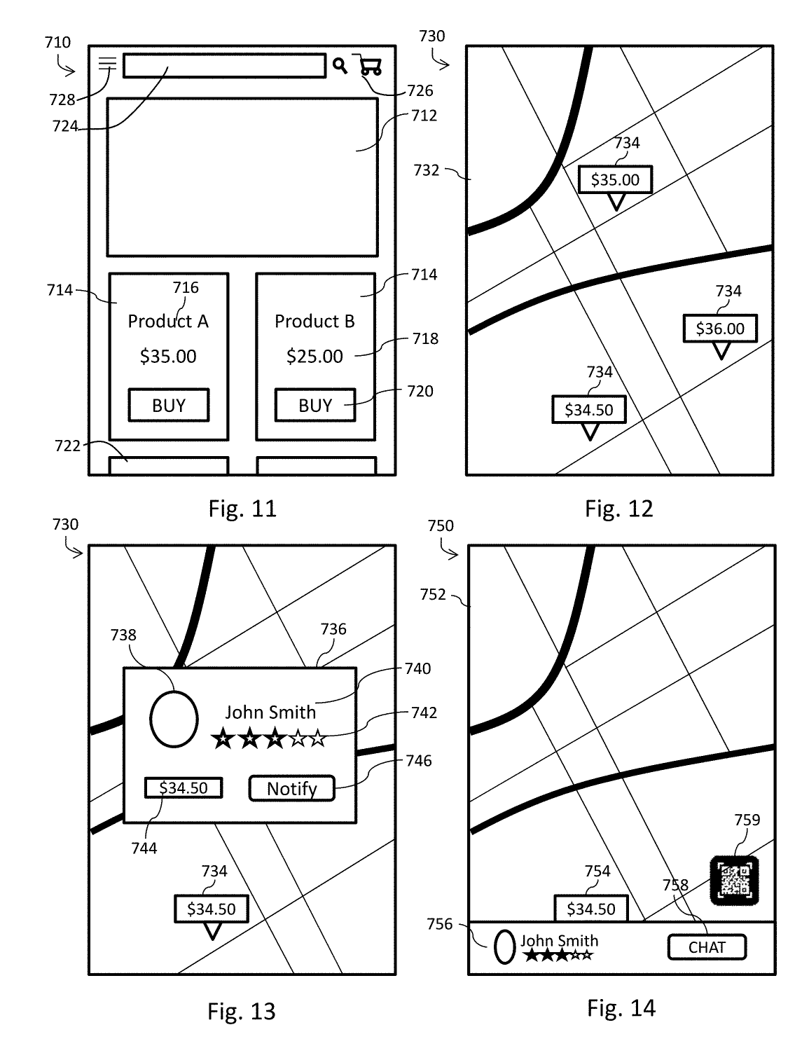

Referring now to FIG. 11, a diagram of the catalog interface of a preferred embodiment of the User App 150 is shown and generally designated 710. The catalog interface 710 includes an announcement region 712 which may contain announcements, news items, advertisements, special offers, or other items of interest to the User 101. If more than one item is available for display in the announcement region 712, the catalog interface 710 cycles through the available items. The User 101 may also swipe to page through the items in order to promptly display a particular item of interest.

Below the announcement region 712 are product displays 714 showing available products. A product display 714 includes a graphical representation of the product, either as a background to the other features described below, or situated above, below, beside, or between them. The product name 716 along with its recommended price 718 is shown. The User 101 can add the product to the shopping card by tapping the buy button 720. Additional product displays 722 may be partially displayed or not displayed due to the limited amount of screen space. The User 101 is provided with a way to scroll through the additional displays 722, such as by moving two fingers across the screen.

A search feature 724 is provided as part of the catalog interface 710. When the User 101 performs a search, the announcement region 712 is omitted from the display, and product displays 714, including partially or wholly obscured displays 722, are provided for products relevant to the search terms.

Once the User 101 has selected any desired products, the shopping cart button 726 allows the User 101 to review the details of the purchase and select payment options. A menu button 728 provides access to additional features of the User App 150, such as profile and purchase history.

Referring now to FIG. 12, if the User 101 selects to pay in cash, an Agent selection interface 730 is displayed. The Agent selection interface 730 includes a map 732 which displays representations 734 of nearby Agents 300. In a preferred embodiment, each representation 734 of a nearby Agent 300 comprises a triangle-shaped arrow feature identifying the location of the corresponding Agent 300, and a tag showing the price the Agent 300 has set for the products in the shopping cart.

Referring now to FIG. 13, if the User 101 taps on one of the representations 374, a dialog 736 is displayed showing the details of the corresponding Agent 300. In preferred embodiments, the dialog includes an avatar 738 corresponding to the Agent 300, the name 740 of the Agent 300, the rating 742 of the Agent 300, the price 744 the Agent 300 has set for the products in the shopping cart, and a button 746 to notify the Agent 300 that the User 101 is making a purchase request.

Referring now to FIG. 14, once the User 101 has made, and the Agent 300 has accepted, a purchase request, a map interface 750 similar to the Agent selection interface 730 is shown. The map interface 750 comprises a map 752, but only displays the location 754 of the selected Agent 300. The Agent details 756 are also displayed in interface 750, along with a chat button 758 allowing the User 101 to initiate a chat session with the Agent 300. A code button 759 is used when the User 101 and the Agent 300 meet to display a code for entry into the Agent App 350 in order to confirm payment. Interface 750 may also include an option to cancel the purchase request.

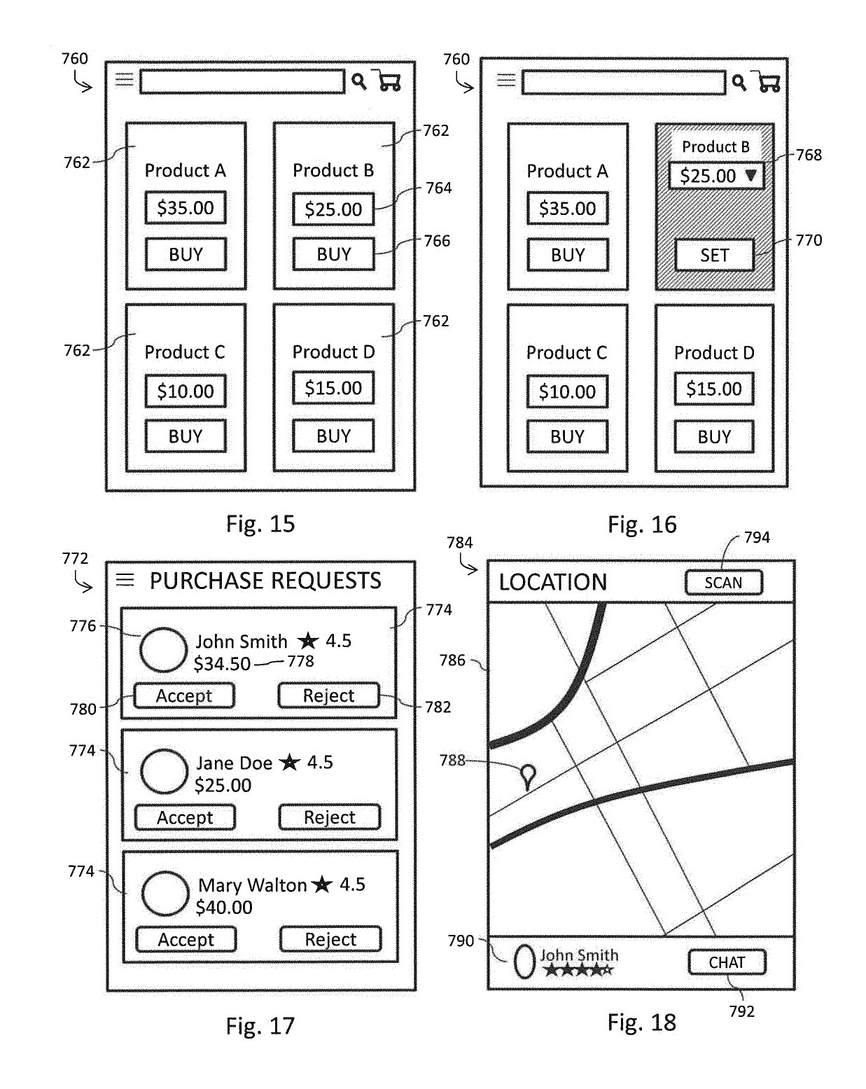

Referring now to FIG. 15, a diagram of the catalog of a preferred embodiment of the Agent App 350 is shown and generally designated 760. The product displays 762 of the catalog 760 are similar to those of the User App 150 catalog 710, and the Agent 300 can scroll to view additional items in the same manner as in the User App 150 catalog 710. Unique to the Agent App 350 is an option 764 to change the price at which the Agent 300 offers the product. A button 766 to add the product to a shopping cart is also available; the button 766 is used to sell products to a third party without the User App 150, but may also be used to purchase products for the Agent 300.

As shown in FIG. 16, when the option 764 to change a price is selected, the catalog 760 interface presents a dropdown menu 768 with the recommended price and several price options above and below the recommended price. In some embodiments, an option is also available which permits the Agent 300 not to offer the particular product. A confirmation button 770 is also presented, which allows the Agent 300 to set the price at which the Agent offers the product to the selected price option.

Referring now to FIG. 17, the Agent App 350 receives and displays notifications of purchase requests from Users 101. A notification interface 772, accessible from the Agent App 350 menu, displays pending purchase requests 774. If there are more pending purchase requests 774 than can be displayed at one time, the Agent 300 can scroll to view additional purchase requests 774 in the same manner in which the catalog 760 can be scrolled. Each purchase request 774 shows the information 776 of the User 101 who made the request, including avatar, name, and rating, and the total amount 778 of the purchase. Each purchase request 774 has an accept button 780 and a reject button 782. If the Agent 300 taps the reject button 782, the User App 150 is notified of the rejection and returns the User 101 to the map display to select another Agent 300. If the Agent 300 taps the accept button 780, the User App 150 is notified, and presents the map interface 750 described in conjunction with FIG. 14.

Referring now to FIG. 18, the Agent App 350 also has a map interface 784 which is displayed when the Agent 300 taps the accept button 780 in the notification interface 772. The map interface 784 shows a map 786, which displays the location 778 of the User 101 who made the purchase request. The information 790 of the User 101 is also displayed, including the name, avatar, and rating of the User 101. A chat button 792, analogous to the chat button 758 of the map interface 750 of the User App 150, allows the Agent 300 to initiate a chat session to communicate with the User 101. When the Agent 300 and the User 101 meet, the Agent uses the scan button 794 to open an interface for inputting a code to confirm that payment for the purchase was made. In a preferred embodiment, the scan button 794 opens an interface which uses a camera on the mobile device on which the Agent App 350 is running in order to read a QR code displayed on the User App 150. An option to manually input a numeric or alphanumeric code displayed on the User App 150 is also available, in case the QR code scan fails or the Agent 300 is otherwise unable to scan the QR code. In some embodiments, the code may be transferred from the User App 150 to the Agent App 350 via NFC, if NFC is available on both the mobile device of the Agent 300 and the mobile device of the user 101.

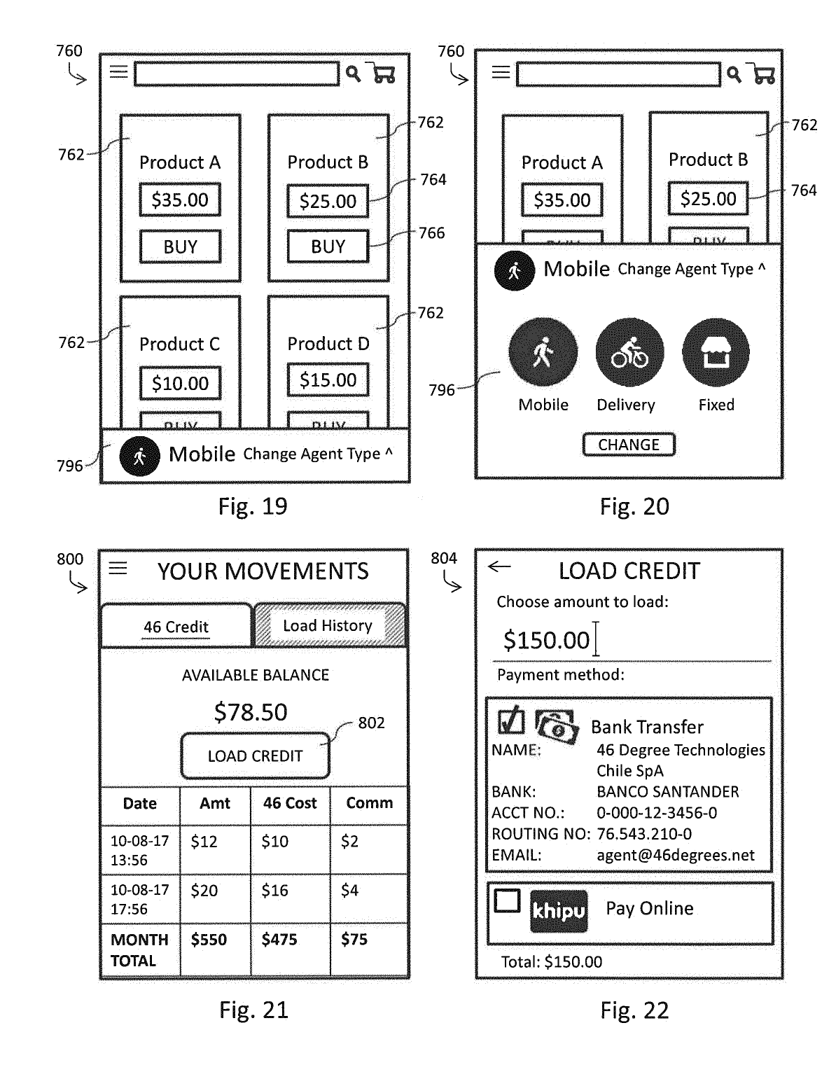

Referring now to FIG. 19, the Agent App 350 may allow the Agent 300 to identify as a certain type of agent. In a preferred embodiment, the Agent 300 is permitted to do so from a change agent interface 796 displayed alongside the catalog 760. In an inactive configuration, the change agent interface 796 displays the current type identification of the Agent 300 and provides the Agent 300 the opportunity to activate the change agent interface 796.

As seen in FIG. 20, the Agent 300 can activate the change agent interface 796 by interacting with the user interface of the Agent App 350. For example, in a preferred embodiment, the user can tap or click on the change agent interface 796 in order to activate it. Activation of the change agent interface 796 expands the change agent interface 796 into an active configuration in which the Agent 300 can select from a predetermined list of agent types in order to identify as the selected agent type. Once an agent type is selected, the Agent 300 may be required to activate an interface feature such as a button 798 in order to confirm the new type identification.

In a preferred embodiment, there are three agent types, including mobile agent, delivery agent, and fixed agent. The type identification of an Agent 300 affects how the Agent 300 is presented to a User 101, either in a User App 150 or a web payment interface, and the instructions given to the User 101 to make a payment and complete a transaction. If a User 101 selects and is accepted by a mobile agent in order to make a payment, the User 101 is instructed to meet with the Agent 300 in order to make a payment. An Agent 300 identifying as a mobile agent does not have a fixed location, so the chat feature of both the User App 150 and Agent App 350, map interface 750, and map interface 784 are used in order for the Agent 300 and User 101 to determine an agreeable location and meet. If the User 101 selects and is accepted by a delivery agent in order to make a payment and complete a transaction, the Agent 300 travels to the location of the User 101. A fixed agent is an Agent 300 that does not travel, such as an Agent 300 operating from a storefront. If the User 101 selects a fixed agent in order to make a payment and complete a transaction, the User 101 is instructed to travel to the location of the Agent 300. In a preferred embodiment, acceptance of the purchase request of a User 101 by a fixed agent is automatic, and the chat feature is disabled. Alternative embodiments allow the fixed agent to accept or reject a purchase request, enable the chat feature with fixed agents, or both.

Referring now to FIG. 21, an accounting interface of the Agent App 350 is shown and generally designated 800. The accounting interface 800 allows an Agent 300 to view the sales history and credit loading (or deposit) history of the Agent 300. The sales history may include the date, total payment amount, base amount (“product cost”), and commission of each payment made to the Agent 300. Generally, the total payment amount is equal to the base amount plus the commission to the Agent 300. The accounting interface 800 includes an option, which may be provided through a button 802, to open a deposit interface 804 (shown in FIG. 22) to deposit or load additional credit into the account of the Agent 300.

As seen in FIG. 22, the deposit interface 804 allows an Agent 300 to add additional credit to the account of the Agent 300. As stated above, preferred embodiments may allow an Agent 300 to add credit to the account of the Agent 300 through one or more of various payment methods, including bank transfer, credit card payment, or a payment service such as PayPal®, WebPay, or Khipu. The Agent 300 enters or selects an amount to load to the account and a payment method. The Agent 300 is then given instructions and/or an interface to make the desired payment.

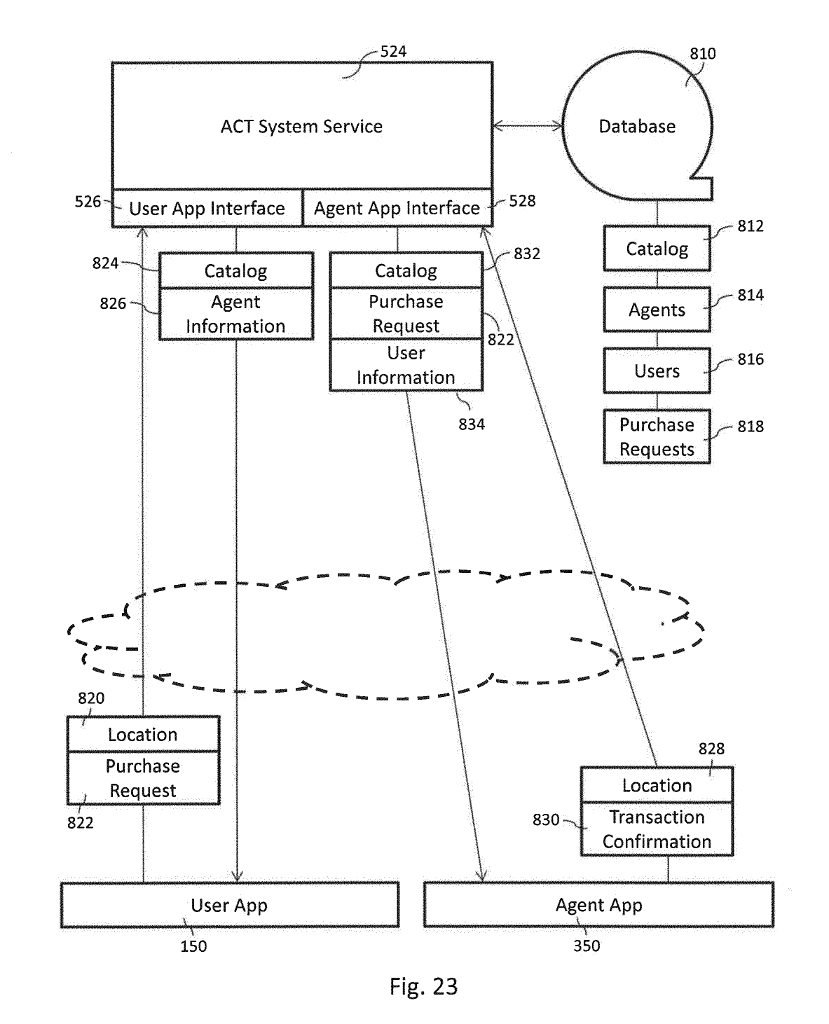

Referring now to FIG. 23, a diagram is shown and provides a general overview of the ACT System Service 524, which provides the platform or backend for the system of the present invention, and its interactions with some of the other components of the present invention. The ACT System Service 524 generally runs on one or more servers, and communicates with one or more databases 810 also running on one or more servers. In a compact embodiment, suitable for a relatively small number of users and agents, the ACT System Service 524 and a single supporting database 810 may run on the same server. In an embodiment appropriate for large-scale implementation, the ACT System Service 524 may run on several servers in different geographical regions in order to provide low-latency, highly responsive service to Users 101 and Agents 350 in various parts of the world, and the persistent data may be stored across multiple databases 810, each of which may be replicated on various servers for quick response time.

The databases 810 store persistent data necessary for operation of the present invention, including a catalog 812 of products; agent account data 814 which includes profile and rating information; user account data 816 which includes profile and rating information; and purchase requests 818. The databases 810 may also store further information, such as order history, shipment data, and other data as necessary or useful to the operation of the present invention. Data is provided between the ACT System Service 524 and the databases 810 through a Database Management Service 532 (shown in FIG. 7). The ACT System Service 524 includes a User App Interface 526 and an Agent App Interface 528.

The User App 150 communicates with the ACT System Service 524 through the User App Interface 526. The User App 150 provides the ACT System Service 524 with frequent updates of the location 820 of the User 101, allowing an Agent 300 to find the User 101 who sent a purchase request 822. Whenever the User 101 makes a purchase request 822, the request 822 is sent to the ACT System Service 524 through the User App Interface 526. The ACT System Service 524, through the User App Interface 526, provides the User App 150 with the information necessary for the User 101 to make purchase requests 822, including catalog information 824, and agent information 826 for nearby Agents 300. Agent information 826 includes the name, avatar, and rating of nearby Agents 300, as well as their locations. When a purchase request 822 has been made and accepted, the ACT System Service 524 provides the User App 150 with agent information 826 for the particular Agent 300 who accepted the purchase request 822, including frequent location updates allowing the User 101 to track the location of the Agent 300 until they meet.

The Agent App 350 communicates with the ACT System Service 524 through the Agent App Interface 528. The Agent App 350 provides the ACT System Service 524 with frequent updates of the location 828 of the Agent 300, allowing Users 101 to find nearby Agents 300. The Agent App 350 also provides confirmations 830 of payments made to the ACT System Service 524, allowing the ACT System Service 524 to transfer the value of the products in the purchase request 822 from the account of the Agent 300 to the vendor's account. The ACT System Service 524 is then able to notify the User App 150 that the transaction has been completed, and provide any digital goods ordered. The ACT System Service 524 provides to the Agent App 350, through the Agent App Interface 528, catalog information 832, purchase requests 822 sent by the User App 150 and destined for the particular Agent 300 using the Agent App 350, and user information 834. User information 834 provides the Agent 300 with information about the user who made the purchase request 822. Once the purchase request 822 has been accepted by the Agent 300, the ACT System Service 524 sends frequent updates of the location of the User 101 so that the Agent 300 can track the User 101 until they meet.

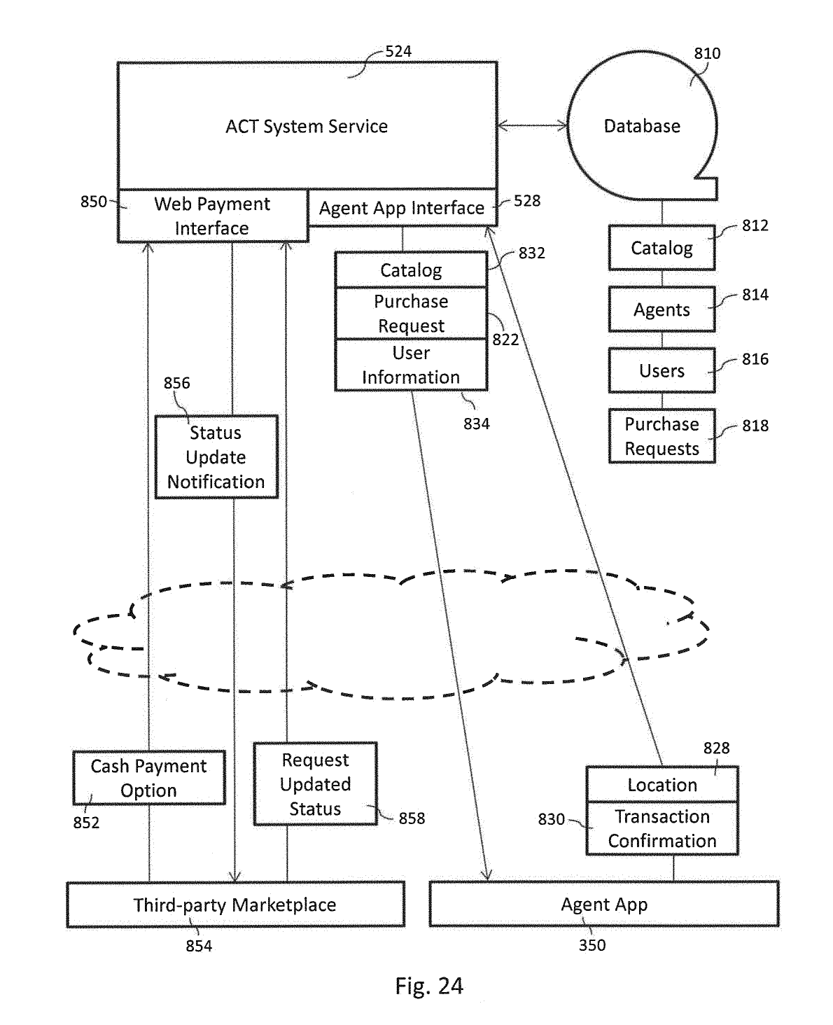

Referring now to FIG. 24, a preferred embodiment of the present invention includes a web payment interface 850 and a cash payment option 852 in place of the User App 150 and the User App Interface 526. It should be noted that the web payment interface 850 and the User App Interface 526 are not mutually exclusive; an embodiment of the present invention includes the User App Interface 526 and User App 150 as well as the web payment interface 850 and payment button 852.

When using the web payment interface 850, a third-party marketplace 854 provides its own catalog to the user. The third-party marketplace can be provided through a website, a mobile application, or some other means which allows users to select products for purchase. Once the user has selected products for purchase, the user is directed, upon selecting a cash payment option 852 on the third-party marketplace 854, to a web application for payment. More particularly, when the user selects the cash payment option 852, the third-party marketplace 854 provides the ACT System Service 524 with a unique identification of the third-party marketplace 854 and the total amount to be charged to the user. The user is then directed to a web application in which the user is enabled to select an agent for cash payment, instructed to meet the selected agent, and provided with a code button 759 to display a code for entry into the Agent App 350 in order to confirm payment. The web application of the web payment interface 850 is substantially similar to, and contains the features of, the portions of the User App 150 used for agent lookup, selection, and payment as described above.

It should be noted that the cash payment option can be presented to the user in a variety of ways. A button, radio button, list selection option or some other form of payment selection mechanism may be used in order to conform to the design of the third-party marketplace. Additionally, the option may be presented as a “cash payment” option, or may be presented as a brand name and/or logo used in conjunction with the platform.

Once payment is confirmed (or if the transaction is cancelled, or another change has taken place), the web payment interface 850 sends a notification 856 to the third-party marketplace 854 that a status change for the order has occurred. In order to provide greater security, and avoid other entities from obtaining the order status information, the status itself is not sent with notification 856. Rather, the third-party marketplace 854 makes a secure request 858 to the web payment interface 850 for the updated status, at which point the status is provided to the third-party marketplace 854. If the status is a confirmation of the payment, the third-party marketplace 854 is then instructed to provide the product to the user.

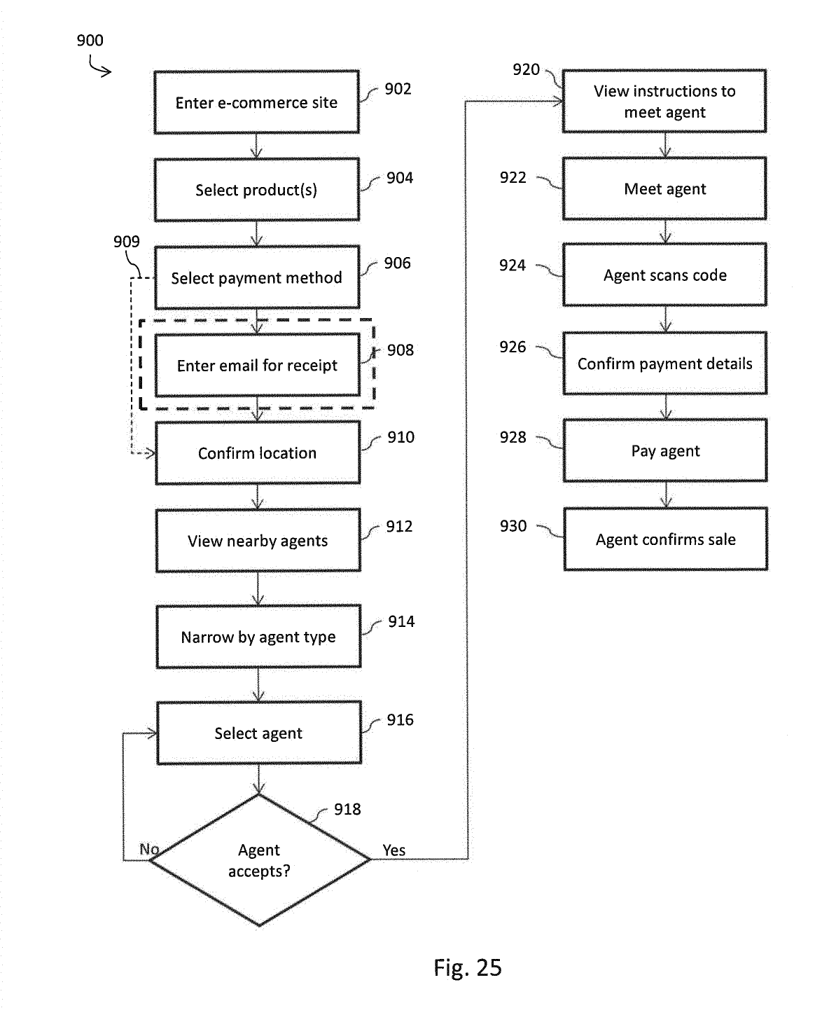

Referring now to FIG. 25, the process of making a payment to a third-party marketplace is shown and generally designated 900. A consumer (or “user”) enters 902 a third-party marketplace, such as an e-commerce site or mobile app, and selects 904 one or more products for purchase. The user then selects 906 to use the ACT system as a payment method, and enters 908 the user's email address as requested. The email address is used to send a receipt or payment confirmation when the transaction is complete, and may additionally be used for the delivery of digital goods by the third-party marketplace.

There may be some instances in which maintaining a user's anonymity is desirable. For example, the third-party marketplace 854 may be a cryptocurrency exchange, such as a bitcoin vendor, and the user may wish to purchase and use bitcoins or another form of cryptocurrency anonymously. Alternatively, the third-party marketplace may be a service provider, such as a web host, and the user may wish to anonymously purchase services in order to express unpopular views, to promote an opposition party in an oppressive regime, or remain anonymous for other purposes. In general, a user may wish to maintain anonymity in the transaction. In such circumstances, the ACT system provides an ideal payment platform, as it allows cash payment and allows the agent to act as a “buffer” between the user and the third-party marketplace 854. A preferred embodiment of the ACT system further aids in maintaining anonymity in transactions by allowing the user to skip 909, or by omitting entirely, the step of entering an email address. In other embodiments, anonymity may still be maintained by using a “throw-away” email account or a temporary or anonymous email service provider.

After the user's email address is entered, the user's location is determined automatically by the system through geolocation. The user confirms 910 or corrects the identified locations, and views 912 nearby agents 300, such as agents 300 within either a predetermined or user-selected distance. The user may then decide to narrow 914 the displayed agents to a specific type of agent. The ACT system may mark up the payment amount based on the agent type, part of which the agent 300 would receive as a commission. The markup may be a specific amount, for example one (1) dollar for a fixed agent, two (2) dollars for a mobile agent, and three (3) dollars for a delivery agent. Alternatively, the markup may be a percentage of the pre-markup payment total, the specific percentage based on the agent type. Or the markup may be a fixed percentage of the pre-markup payment amount, plus a specific amount based on the agent type. In a preferred embodiment, the markup is a fixed amount based on the agent type if the pre-markup payment total is below a certain threshold, such as fifteen (15) dollars, and a percentage of the pre-markup payment total if the pre-markup payment total is above the threshold.

When the user selects 916 an agent 300, a purchase request is sent to the agent 300 via the agent app 350. If the agent accepts 918 the purchase request, the user views 920 instructions to meet the agent. If the agent rejects the purchase request, the user selects 916 another agent.

The instructions to meet the agent may be distinct for each agent type. For example, the user may be instructed to go to a certain location to meet a fixed agent, or arrange to meet at a certain location with a mobile agent, or wait for a delivery agent to arrive at the user's location. The user then meets 922 the agent, who then scans 924 or enters a code displayed on the user's phone. The code identifies the transaction to the ACT system, and the agent app 350 displays the payment details, including the total amount of the payment, the marketplace, and the user's email address. The user confirms 926 to the agent 300 that the details are correct, and pays 928 the agent 300 the cash value of the total payment amount. The agent 300 then confirms 930 the sale through the agent app 350, upon which the agent's account balance is deducted by the payment amount (minus the agent's commission) and the marketplace is instructed to provide the purchased goods or services to the user.

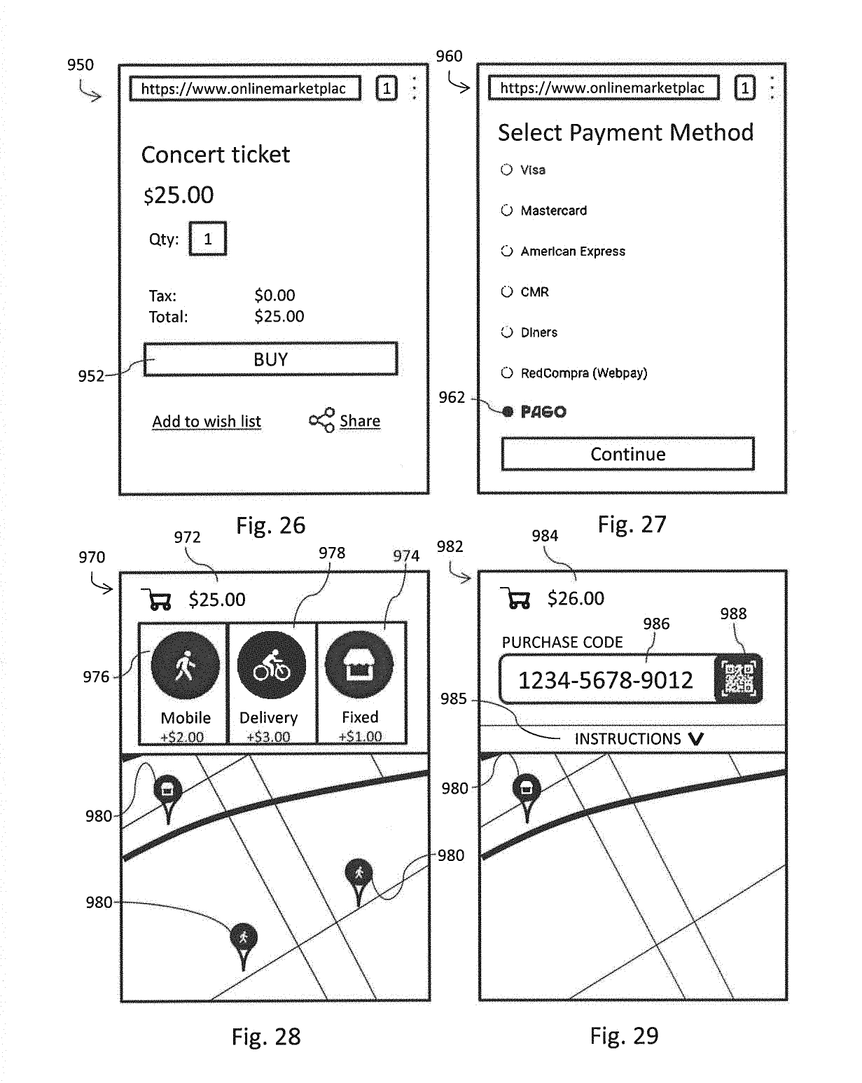

Referring now to FIG. 26, an example of an online marketplace 950 is shown. The user selects one or more products for purchase, and uses an element 952 of the marketplace's interface to indicate a desire to purchase the products.

As shown in FIG. 27, in order to complete the purchase, the marketplace provides an interface 960 to select a payment method. Among the available payment methods is an option 962 to make a cash payment through the web payment interface 850 of the ACT system.

Referring now to FIG. 28, if the user elects to make a cash payment through the web payment interface 850 of the ACT system, the user is presented with an agent selection interface 970. The agent selection interface may show the pre-markup payment total 972. Additionally, the payment interface may include an interface element 974 for limiting the displayed agents to fixed agents, an interface element 976 for limiting the displayed agents to mobile agents, and an interface element 978 for limiting the displayed agents to delivery agents. Interface elements 974, 976, and 978 may include the calculated markup amount for each type of agent. In a preferred embodiment, representations 980 of nearby agents 300 are shown on a map. In a preferred embodiment, representations 980 include an icon or other interface feature designating the type of each agent.

Referring now to FIG. 29, if the user selects an interface element 974, 976, or 978, or if the user selects a particular agent 300, the payment total 984 including the markup may be shown. Once a particular agent 300 is selected, an instructions interface 985 is provided whereby the user can view instructions to meet the agent 300. A purchase code 986 is provided that the agent 300 can use to confirm payment. In a preferred embodiment, a button 988 allows the user to display a QR code that can be scanned by the Agent App 350 in place of entry of the code 986.

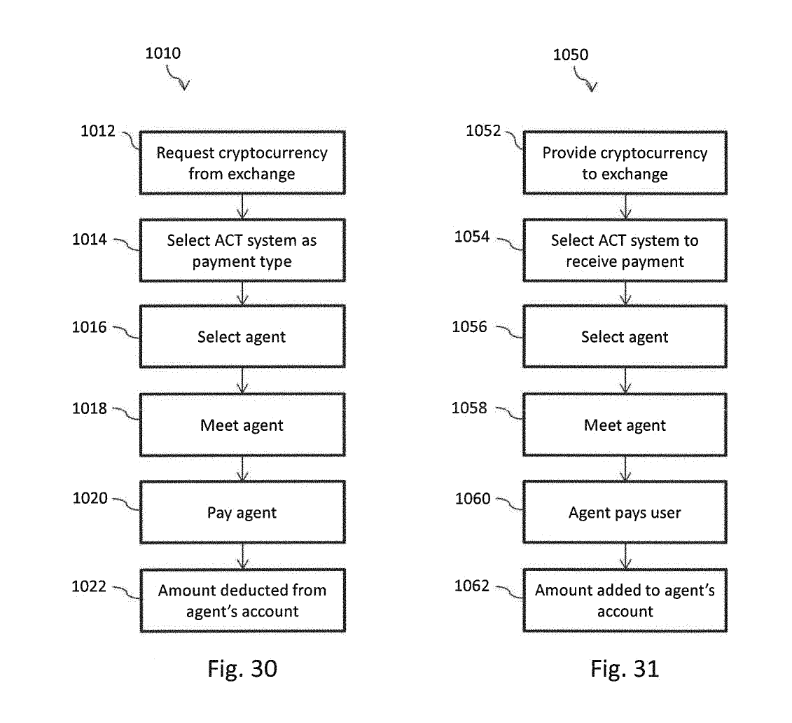

Referring now to FIG. 30, an overview of the process of purchasing cryptocurrency from an exchange is depicted and generally referred to as 1010. Anonymity is often important in transactions involving cryptocurrencies such as bitcoin, and the ACT system can provide a buffer between the user and the exchange. The process of purchasing cryptocurrency is generally the same as the process of purchasing from any other vendor or marketplace, as depicted in greater detail in FIG. 25. As seen in FIG. 30, the user requests 1012 a certain amount of cryptocurrency from the exchange. This is performed through the cryptocurrency exchange's normal system, as with any third-party marketplace. The user then selects 1014 the ACT system as the payment method. The normal agent selection process 1016 is followed, and, if the agent accepts the transaction, the user meets 1018 and pays 1020 the agent. When the agent confirms the transaction, the agent's account balance is deducted by the payment amount (minus the agent's commission) and the exchange is instructed to provide the purchased cryptocurrency to the user, as described in connection with FIG. 24.

Referring now to FIG. 31, the user may also want to sell cryptocurrency to an exchange. A preferred embodiment of the ACT system allows a vendor to provide payment to users as well as receive payments from users. This process is depicted in FIG. 31 in connection with a cryptocurrency exchange and generally designated 1050. The user first provides 1052 cryptocurrency to the exchange. Alternatively, the user may provide any acceptable goods or services to any marketplace making outgoing payments. Once the cryptocurrency is received by the exchange, or other goods or services received by the marketplace, the exchange or marketplace requests the user to select a method for receiving payment. The user selects 1054 to receive payment through the ACT system. The general process is the same as the process for making payments to a third-party marketplace. The user selects 1056 and meets 1058 an agent. Substantially the same process described in connection with FIG. 25 may be performed, with the exception, as seen in FIG. 31, that the agent pays 1060 the cash amount to the user, which is the amount of the cryptocurrency exchange's payment for the amount of cryptocurrency sold by the user (or the marketplace's payment for the goods and services) minus an amount retained by the ACT system calculated in the same manner as the markup described in connection with FIGS. 25 and 28 above. When the transaction is confirmed, the amount paid out, plus the agent's commission, is added 1062 to the agent's account.

While there have been shown what are presently considered to be preferred embodiments of the present invention, it will be apparent to those skilled in the art that various changes and modifications can be made herein without departing from the scope and spirit of the invention.

What is claimed is:

1. A method for accessing an on-demand service on a computing device, the method being performed by one or more processors and comprising:
providing, on a display of the computing device, a payment selection feature that is operative by a user to elect to make a cash payment;
receiving, in connection with the payment selection feature, a user input to elect to make a cash payment;
determining a current location of the computing device;
providing, on the display, an agent selection feature that is operative by a user to select one of a set of agents within a predetermined distance from the location of the computing device;
receiving, in connection with the agent selection feature, a user input to select an agent from the set of agents; and
sending, via a network interface, a notification to the selected agent of the election to make a cash payment.

2. The method as recited in claim 1, wherein the agent selection feature comprises a user interface comprising a map, and wherein each agent of the set of agents is depicted on a portion of the map representing its location.

4. The method as recited in claim 1, further comprising the steps of:
receiving, via the network interface, a first response from the agent, the first response comprising an offer to receive payment;
providing, on the display, instructions to the user to engage in a transaction with the agent;
receiving, via the network interface, a second response from the agent, the second response comprising a confirmation of payment; and
providing a notification of payment to a selling party.

4. The method as recited in claim 3, wherein the step of providing a notification comprises:
updating a status associated with the cash payment;
notifying the selling party of the update of the status;
receiving a request from the selling party to provide the updated status; and
providing, in response to the request, the updated status to the selling party.

5. The method as recited in claim 3, wherein the instructions to the user to engage in a transaction with the agent comprise a map showing a location of the agent.

6. The method as recited in claim 5, wherein the instructions to the user to engage in a transaction with the agent further comprise a chat feature configured to allow the user to engage in text-based communication with the agent.

7. The method as recited in claim 4, wherein the step of determining a current location of the computing device is performed using a GPS sensor component of the computing device.

8. The method as recited in claim 7, wherein the step of determining a current location of the computing device comprises:
providing, on the display, a location entry feature showing the location determined by the GPS sensor component of the computing device that is operative by a user to confirm the location; and
receiving, in connection with the location entry feature, a user input to confirm the location.

9. The method as recited in claim 4, wherein the step of determining a current location of the computing device comprises:
providing, on the display, a location entry feature that is operative by a user to select a location; and
receiving, in connection with the location entry feature, a user input to select a location.

10. A non-transitory computer-readable medium storing instructions that, when executed by one or more processors of a computing system, cause the computing system to perform operations comprising:
providing, on a display of the computing device, a payment selection feature that is operative by a user to elect to make a cash payment;
receiving, in connection with the payment selection feature, a user input to elect to make a cash payment;
determining a current location of the computing device;
providing, on the display, an agent selection feature that is operative by a user to select one of a set of agents within a predetermined distance from the location of the computing device;
receiving, in connection with the agent selection feature, a user input to select an agent from the set of agents; and
sending, via a network interface, a notification to the selected agent of the election to make a cash payment.

11. The non-transitory computer readable medium as recited in claim 10, wherein the agent selection feature comprises a user interface comprising a map, and wherein each agent of the set of agents is depicted on a portion of the map representing its location.

12. The non-transitory computer readable medium as recited in claim 10, further comprising stored instructions that when executed by one or more processors of a computing system, cause the computing system to perform operations comprising:
receiving, via the network interface, a first response from the agent, the first response comprising an offer to receive payment;
providing, on the display, instructions to the user to engage in a transaction with the agent;
receiving, via the network interface, a second response from the agent, the second response comprising a confirmation of payment; and
providing a notification of payment to a selling party.

13. The non-transitory computer readable medium as recited in claim 12, wherein the instructions to the user to engage in a transaction with the agent comprise a map showing a location of the agent.

14. The non-transitory computer readable medium as recited in claim 13, wherein the instructions to the user to engage in a transaction with the agent further comprise a chat feature configured to allow the user to engage in text-based communication with the agent.

15. The non-transitory computer readable medium as recited in claim 13, wherein the operation of determining a current location of the computing device is performed using a GPS sensor component of the computing device.

16. A system for cash based transactions with an online vendor, comprising:
a backend transaction management system, comprising:
a processing component comprising at least one processor and a processor memory component,
a storage component,
a network interface,
a database management service,
a product catalog service,
a web payment interface, and
an agent app interface;
an agent app, comprising:
a location service configured to send location data to the backend transaction management system,
a procedure for notifying an agent of a purchase request,
a procedure for accepting a purchase request, and
a procedure for confirming completion of a transaction;
a marketplace, comprising:
a procedure for creating a purchase request, and
a procedure for identifying the created purchase request;
one or more agent devices, comprising:
a processing component executing an instance of the agent app,
a location sensor configured to provide location data to the instance of the agent app,
a display, and
touchscreen means for receiving input; and
one or more user devices, comprising:
a processing component executing instructions resulting in providing access to the marketplace,
a display, and
means for receiving input,
wherein the procedure for creating a purchase request of the marketplace performs operations comprising:
receiving information about one or more products from the product catalog service of the backend transaction system,
providing, on a display of a user device of said one or more user devices, a product selection feature that is operative by a user to select one or more products;
receiving, in connection with the product selection feature, a user input to select one or more of the products;
sending the location of the user device running the procedure for creating a purchase request of the marketplace to the backend transaction management system;
receiving location information of nearby agent devices from the backend transaction management system;
providing, on the display of the user device, an agent selection feature that is operative by a user to select an agent identified from the location information of nearby agent devices;
creating a purchase request; and
providing, on the display of the user device, an identification of the created purchase request,
wherein the procedure for confirming completion of a transaction of the agent app performs operations comprising:
receiving input comprising the identification of the created purchase request provided by the procedure for creating a purchase request of the marketplace; and
providing a confirmation notification comprising the identification of the created purchase request to the backend transaction management system, and
wherein the backend transaction management system, upon receipt of a confirmation notification from the procedure for confirming completion of a transaction of the agent app, notifies the instance of the user app that created the purchase request of the confirmation.

17. The system for cash based transactions with an online vendor as recited in claim 16, wherein the one or more user devices further comprises a GPS sensor, and wherein the web payment interface is configured to obtain the location of the user device accessing the marketplace from the GPS sensor.

18. The system for cash based transactions with an online vendor as recited in claim 16, wherein the web payment interface obtains the location of the user device accessing the marketplace from an input from a user.

19. The system for cash based transactions with an online vendor as recited in claim 16, wherein the means for receiving input of the one or more user devices comprises a touchscreen.

20. The system for cash based transactions with an online vendor as recited in claim 16, wherein the location sensor of the one or more agent devices comprises a GPS sensor.
